(19) United States
(12) Patent Application Publication
(10) Pub. No.: US 2022/0272990 A1
(43) Pub. Date: Sep. 1, 2022

(54) Methods and Compositions of the Botanical Extract to Promote and Boost Plant Growth and Prevent and Suppress Plant Diseases

(71) Applicant: Produits Bio Sun Inc., Montreal (CA)

(72) Inventors: Guy Chamberland, Boucherville, Quebec (CA); Jamil Samsatly, Montreal, Quebec (CA)

(21) Appl. No.: 17/597,823

(22) PCT Filed: Jul. 27, 2020
(86) PCT No.: PCT/CA2020/051030

§ 371 Date: Jan. 25, 2022

Related U.S. Application Data
(60) Provisional application No. 62/878,600, filed on Jul. 25, 2019.

(51) Int. Cl. A01N 65/22; A01N 65/12; A01N 65/03; A01N 65/08; A01P 1/00; A01P 3/00

(52) U.S. Cl. CPC A01N 65/22; A01N 65/12; A01N 65/03; A01N 65/08; A01P 1/00; A01P 3/00

(57) ABSTRACT

A botanical composition to be applied as foliar application or soil drench on plant to promote growth and to prevent or suppress diseases on the said plants. The botanical composition comprises a granular extract of thyme leaf and an extract of Chelidonium majus. The composition is typically diluted at a concentration between 0.2% to 5%.

### CROSS-REFERENCE TO RELATED APPLICATIONS

The present patent application claims the benefits of priority of commonly assigned U.S. Patent Application No. 62/878,600 entitled “METHODS AND COMPOSITIONS OF THE BOTANICAL EXTRACT CELEXT07 TO PROMOTE AND BOOST PLANT GROWTH AND PREVENT AND SUPRESS PLANT DISEASES” and filed at the United States Patent and Trademark Office on Jul. 25, 2019.

### FIELD OF THE INVENTION

The present invention generally relates to botanical extract for the growth and protection of plants.

### BACKGROUND OF THE INVENTION

There have been multiple solutions marketed to help plants grow or heal from diseases. Some of them are using chemicals wherein others are using organic components. Chemical solutions, even if they often provide the best results, may have adverse effects to the health of humans in contact with treated plants. On the other hand, organic solutions are often not as efficient as necessary. Therefore, there is a need for an organic solution that is as efficient, if not more, than most chemical solutions found on the market in order to help plants grow and heal from diseases.

Herbal extracts used in agriculture are formulated from naturally occurring plants (or other organisms) as alternatives to synthetic chemicals that could be more toxic to growers, consumers, and more harmful to the environment. Advantages such products could involve biodegradability and more eco-friendly to nature, due to no harmful residues, compared to synthetic chemical alternatives. Because of the listed advantages, agricultural industries all over the world are developing botanicals to contribute to sustainable agriculture. Testing the efficacy of these products on the initial stages of plants' growth cycle (germination and early seedling growth) is an expensive and time-consuming process. Germination rates are usually determined by petri dish assays. For early growth, another system involving hydroponics or greenhouse growth (direct germination) are usually used. A Standard Operating Procedure was developed for analysis of the impact of herbal extracts on germination and early growth (SOP). This was done in a defined system by modifying the rolled paper towel test developed by the International Seed Testing Association (ISTA, 1985). The efficacy of SOP was determined by comparing it with direct germination test. The SOP has the following advantages: (1) efficient for testing the effect of potential growth stimulants on seed germination and early growth; (2) time (2 weeks duration) and space efficient; (3) repeatable; performed under defined conditions in a growth chamber; (4) relatively simple and low-cost method that can be performed in industry by staff with minimal training and easily available materials.

### SUMMARY OF THE INVENTION

The aforesaid and other objectives of the present invention are realized by generally providing a botanical composition to promote plant growth and to prevent or suppress plant diseases.

In an aspect of the present invention, a botanical composition is provided. The botanical composition comprises a granular extract of thyme leaf, an extract of Chelidonium majus roots and an extract of Chelidonium majus leaves. The composition is diluted at a concentration between 0.2% to 5% and the composition is used to promote plant growth and to prevent or supress plant diseases.

The botanical composition may comprise 0.1% to 99% of the extract of Chelidonium majus roots, 0.1% to 99% of the extract of Chelidonium majus leaves and 0.1% to 30% of the granular extract of thyme leaf.

The botanical composition may be diluted at a concentration between 0.5% and 5%. The botanical composition may have anti-bacterial and/or anti-fungal properties. The botanical composition may further comprise a tincture or seaweed. The seaweed may be Ascophyllum nodosum. The composition may comprise between 0.5 to 2 g/L of seaweed.

The composition may further comprises an additional extract of thyme leaf. The extract of thyme leaf may be a thyme leaf extract diluted in 1:2 in 50% alcohol.

The composition may further comprise thymol or an extract of yarrow leaf. The yarrow leaf extract may be diluted in 1:2 in 50% alcohol.

The botanical composition may further comprise a soil mix. The soil mix may comprise coconut husk fiber. The soil mix may further comprise peat moss and perlite or mycorrhiza.

In an other aspect of the invention, a botanical composition is provided. The botanical composition comprises an extract of yarrow leaf diluted in 1:2 in 50% alcohol the composition being used to promote plant growth and to prevent or supress plant diseases. The botanical composition may further have anti-bacterial and/or anti-fungal properties.

The extracts may be prepared using cold pressing or freeze drying. The extracts may further be prepared using a technique that involves processing using fermentation. The fermentation may be aerobic or anaerobic. The bacteria created may be lactic acid bacteria or may originate from the Bacillus species.

In yet another aspect of the invention, a method of treating plants using a botanical composition is provided. The botanical composition comprises a granular extract of thyme leaf, an extract of Chelidonium majus, concentration between 0.2% to 5%, the method further comprises soil-drenching plants using a concentration between 0.2% to 5% of the botanical composition. In such a method, the soil-drenching may be applied in a single dose or may be applied in split doses over a predetermined period of time.

In a further aspect of the invention, a method of treating plants using a botanical composition is provided where the botanical composition comprises a granular extract of thyme leaf, an extract of Chelidonium majus, concentration between 0.2% to 5%. The method comprises applying a concentration between 0.2% to 5% of the botanical composition on leaves of the plants. The application of the botanical composition may comprise dipping the leaves in the botanical composition. The application of the botanical composition may further comprise spraying the leaves with the botanical composition.

The botanical composition may be applied by spraying or dipping the leaves in a single dose or in split doses over a predetermined period of time.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1A is an illustration of exemplary tomato plants, a first tomato plant being the control and the other tomato plants being treated with different compositions of a botanical extract in accordance with the principles of the present invention, the illustration showing a height indicator.

FIG. 1B is an illustration of the tomato plants of FIG. 1A showing chlorophyll indicator.

FIG. 2 is an illustration of exemplary lettuce plants grown under greenhouse conditions, a first lettuce plant being the control and the other lettuce plants being treated with different compositions of a botanical extract in accordance with the principles of the present invention.

FIG. 3 an illustration of the lettuce plants of FIG. 2 shown with roots.

FIG. 4A is an illustration of exemplary lettuce plants grown in single pots, a first lettuce plant being the control and the other lettuce plant being treated with a composition of a botanical extract in accordance with the principles of the present invention.

FIG. 4B an illustration of the lettuce plants of FIG. 4A shown outside of the pots and without soil.

FIG. 5A is an illustration of exemplary tobacco plants grown in single pots, a first tobacco plant being the control and the other tobacco plant being treated with a composition of a botanical extract in accordance with the principles of the present invention.

FIG. 5B an illustration of the tobacco plants of FIG. 4A shown outside of the pots and without soil.

FIG. 6 is an illustration of standard operating procedures (SOP) for soybean germination in accordance with the principles of the present invention.

FIG. 7 is an illustration of exemplary cannabis buds having same genetics, the cannabis buds on the left being treated with a biostimulant composition of a botanical extract in accordance with the principles of the present invention.

FIG. 8A is an illustration of exemplary lettuce leaves infected with Botrytis plugs in a first trial, a first lettuce leaf being the control and the other lettuce leaves being treated with different compositions of a botanical extract in accordance with the principles of the present invention.

FIG. 8B is an illustration of exemplary lettuce leaves infected with Botrytis plugs in a second trial, a first lettuce leaf being the control and the other lettuce leaves being treated with different compositions of a botanical extract in accordance with the principles of the present invention.

FIG. 9A is a graph showing a disease index of detached leaves of soil drenched healthy plants treated with water and a composition of botanical extract in accordance with the principles of the present invention and post-infected with B. cinerea, the first leaf being the control and the others being treated with different compositions of the water and botanical extract s.

FIG. 9B is an illustration the detached leaves of FIG. 9A.

FIG. 10A is an illustration of tomato plants treated with soil drench treatment using different compositions of a botanical extract in accordance with the principles of the present invention.

FIG. 10B is an illustration of a humidity tent positioned over the infected tomato plants of FIG. 10A.

FIG. 10C is a graphical representation of disease indexes and attached tomato plant leaves of a control plant and of other plants treated with the different compositions of the botanical extract of FIG. 10A.

FIG. 10D is an illustration of B. cinerea on leaves of the tomato plants of FIG. 10A, the left plant being the control and the right plant being treated with a composition having 1% of the botanical extract of FIG. 10A.

FIG. 11A is an illustration of soil drenched tomato plants, a first plant being the control and the others being treated with different concentrations of a botanical extract in accordance with the principles of the present invention.

FIG. 11B is an illustration of a disease index of the soil drenched tomato plants of FIG. 11A.

FIG. 12A is an illustration of lettuce (left) and tomato (right) leaves, the top row of leaves being the control and the bottom row of leaves being submerged in a botanical extract in accordance with the principles of the present invention and being challenged with B. cinerea.

FIG. 12B is an illustration of disease indexes of the lettuce and tomato leaves of FIG. 12A.

FIG. 13 is an illustration of exemplary phytotoxic responses of detached hops leaves treated with 1% and 2% concentration of botanical extracts in accordance with the principles of the present invention, with 1.5% bleach and with water (control), the leaves being shown 48 h after the treatment.

FIG. 14 is an illustration of examples of inoculation with B. cinerea of detached hops leaves, the top leaves being treated with 1% concentration of botanical extracts in accordance with the principles of the present invention and the bottom leaves being treated with water, the leaves being showed about 48 h after inoculation.

FIG. 15 is an illustration of exemplary hops grown in a controlled growth chamber and treated with botanicals using a soil drench method in accordance with the principles of the present invention.

FIG. 16A is a software rendering of disease severity using ImageJ software (left portion) showing percentage of necrotic lesion caused by Botrytis on hops treated with soil drenched botanical extracts in accordance with the principles of the present invention and the image prior to adding the software rendering (right portion).

FIG. 16B is an illustration of soil-drenched hops challenged with B. cinerea using detached hops leaves, a first treated with water (control) and others being treated with different concentrations of botanical extracts in accordance with the principles of the present invention.

FIG. 17 is a graph showing the percentage area and percentage incidence of infected hops leaves as a function of the control and of different concentrations of botanical extracts in accordance with the principles of the present invention.

FIG. 18 is an illustration of exemplary phytotoxic response of Cannabis detached leaves treated with a water treatment (T5) and with 1% concentrations of botanical extracts in accordance with the principles of the present invention, the leaves being shown 6 days after the treatments.

FIG. 19A is an illustration of a method of inoculation of detached leaves of Cannabis treated with botanical extracts or with control in accordance with the principles of the present invention using powdery mildew (PM) infected leaves as a source of inoculum.

FIG. 19B is an illustration of the leaves shown in FIG. 19A having PM, 8 days post-inoculation in accordance with the principles of the present invention, where arrows indicate signs or symptoms of infection.

FIG. 20 is a software rendering of the severity of disease of Cannabis leaves infected with PM and treated in with a botanical extract in accordance with the principles of the present invention.

FIG. 21 is an illustration of a second trial wherein three variety of Cannabis have been treated with a control or botanical extract in accordance with the principles of the present invention used with thymol.

FIG. 22 is a graph of percent area of infected detached Cannabis leaves treated with water (control) or with botanical extracts in accordance with the principles of the present invention as a function of the varieties shown in FIG. 21.

FIG. 23 is an illustration of disease progression at 39 DPI days post-inoculation of different varieties of Cannabis leaves treated with water (control) and with a 1% botanical extract in accordance with the principles of the present invention used with thymol.

FIG. 24 is an illustration of Cannabis plants showing high level infestations of powdery mildew.

FIG. 25A is an illustration of Xanthomonas with a concentration of 1% to 5% of botanical extract in accordance with the principles of the present invention.

FIG. 25B is an illustration of Xanthomonas combined with thyme extract (1:2 in 50% alcohols).

FIG. 25C is an illustration of Xanthomonas combined with yarrow extract (1:2 in 50% alcohol).

FIGS. 26A to 26C are illustrations of environmental Salmonella (S22) with thyme and yarrow treated with botanical extracts in accordance with the principles of the present invention.

FIG. 27 is an illustration of pathogenic Salmonella (S1), a first treated with control and others being thyme, yarrow extracts, and concentrations of a botanical extract in accordance with the principles of the present invention.

FIG. 28 is an illustration of Salmonella (S31—mungbean sprout isolate) with thyme.

FIG. 29 is an illustration of Streptomyces scabies with thymes (upper illustrations) and yarrow extracts (lower illustrations).

FIG. 30 is an illustration of growth of Fusarium graminearum after inoculation with different concentrations of a botanical extract in accordance with the principles of the present invention, the left plate being a PDA plate 24 hours after inoculating with F. graminearum and the right PDA plate being 72 hours after inoculating with F. graminearum.

FIG. 31 is an illustration of the growth of Fusarium graminearum with thyme and yarrow extract, the left PDA plate being 24 hours after inoculating with F. graminearum and the right PDA plate being 72 hours after inoculating with F. graminearum, T being thyme leaf and Y being yarrow extracts, both T and Y being developed and prepared by the Applicant, T+ and Y+ being respectively commercially available thyme and yarrow extracts.

FIG. 32A is an illustration of antimicrobial and MIC assays, some being control treated and some being treated with different concentrations of a botanical extract in accordance with the principles of the present invention.

FIG. 32B is an illustration of antimicrobial and MIC assays using a combination of different concentrations of with a combination of a botanical extract in accordance with the principles of the present invention with a commercial thymol.

FIG. 33 is an illustration of Aspergillus ochraceus antifungal and MIC assays using thymol or a combination of a botanical extract in accordance with the principles of the present invention with a commercial thymol.

FIG. 34 comprises illustrations of Fusarium graminearum spores germinating after being incubated at different period of times in a solution of different concentrations of a botanical extract in accordance with the principles of the present invention at different times (between 24 h and 48 h).

FIG. 35 comprises 20× illustration of Fusarium graminearum spores germinating after being incubated for different period of times in a solution of different concentrations of a botanical extract in accordance with the principles of the present invention.

### DETAILED DESCRIPTION OF THE PREFERRED EMBODIMENT

Novel methods and compositions of a botanical extract to promote and boost plant growth and prevent and suppress plant diseases will be described hereinafter. Although the invention is described in terms of specific illustrative embodiment(s), it is to be understood that the embodiment(s) described herein are by way of example only and that the scope of the invention is not intended to be limited thereby.

A botanical composition or mixture of a granular extract of thyme (Thymus vulgaris) and an extract of roots, leaves or a mixture thereof of Chelidonium majus (Chelidonium majus) to promote plant growth and prevent or suppress plant diseases is provided. The botanical composition may have different concentrations, such as but not limited to concentrations w/v 0.2%, 0.5%, 1.0%, 1.5%, 2% & 5%. The concentrations are typically prepared in distilled water and filter sterilized. In the present disclosure, unless specifically mentioned, the term thymol generally refers to thyme leaf extract that was diluted 1:2 in a 50% alcohol tincture before being added to the botanical composition or mixture. Furthermore, as in mentioned for some experiments, yarrow flower extract was diluted 1:2 in a 50% alcohol tincture before being used.

The botanical composition or mixture of a granular extract of thyme (Thymus vulgaris) and an extract of roots, leaves or a mixture thereof of Chelidonium majus (Chelidonium majus) may be used as a biostimulant, as described above. Extracts of roots, leaves or both may be in combination with a specific portion of thyme.

The relative quantity of thyme and root and leaf used in a mixture may be in the following ranges:
0.1% to 99% of the extract of Chelidonium majus roots;
0.1% to 99% of the extract of Chelidonium majus leaves; and
0.1% to 30% of the granular extract of thyme leaf

The extraction process of Chelidonium majus may be executed conventionally (10:1-70% ethanol) followed by spray drying, or with cold pressing or with freeze drying.

The extraction process of Chelidonium majus may further be done with various bacterias, either using aerobic or anaerobic fermentation. One such example of bacteria to use in an extraction process is the lactic acid bacteria, also referred to as LAB. Bacterias of the Bacillus species may also be used in the process.

More thyme leaves and/or yarrow leaves or any other parts of thyme or yarrow may further be added to the composition.

### Example I: Growth Effect of the Botanical Composition of Thyme and C. majus on Tomato Plants Grown in Tissue Culture

In a first example, roots of tomato seedlings have been treated in tissue culture with the botanical composition at different exemplary compositions (0.5%, 1% & 2%). After three weeks of treatments, tomato plants were removed from tissue culture tubes and chlorophyll content, and plant height was recorded.

The results show that after three weeks, roots of tomato seedlings treated in tissue culture with the botanical composition (0.5%, 1% & 2%) had higher chlorophyll content and the total plant height was higher compared to the control.

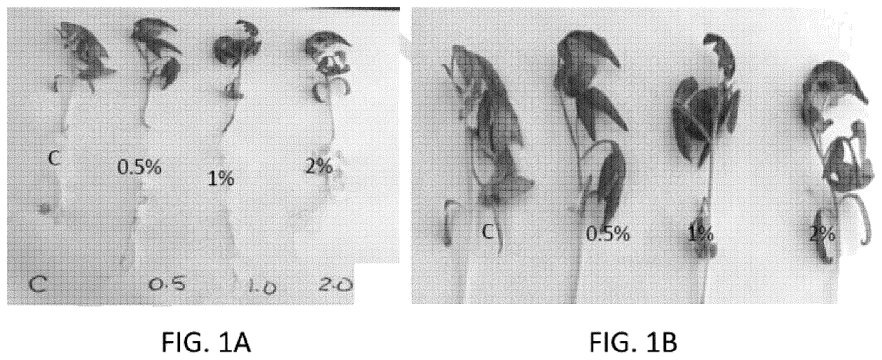

Referring now to FIGS. 1A and 1B, exemplary tomato plants are illustrated, the tomato plants being treated with different concentrations of the botanical composition (0.0% (control), 0.5%, 1% and 2%). FIG. 1A shows a height indicator and FIG. 1B shows a chlorophyll indicator.

Table 1: Chlorophyll content (μg.cm-2) of control and the botanical composition treated tomato plants. Numbers in the table represent the average of two compound leaves per plant. Three separate readings per leaf was recorded.

TABLE 1
Chlorophyll content (μg · cm−2) of the treated
tomato plants when treated with a control and with
different concentrations of the botanical composition.

| | Botannical | Botannical | Botannical |
|---|---|---|---|
| | composition | composition | composition |
| Control | (0.5%) | (1.0%) | (2.0%) |

Chlorophyll content

| | | | | |
|---|---|---|---|---|
| R1 | 20.4 | 29.6 | 43.9 | 40.7 |
| R2 | 22.9 | 29.8 | 44.4 | 41.7 |
| Average | 21.65 | 29.7 | 44.2 | 41.2 |

Plant Height*

| | | | |
|---|---|---|---|
| 18.7 cm | 23.0 cm | 25.7 cm | 21.5 cm |

*Plant height was only recorded from one plant for each treatment.

### Example II—Effect of Botanical Extracts on Growth of Young Plants Under Greenhouse Conditions

### A—Experiments Regarding the Botanical Extracts Under Greenhouse Conditions in Trays Located in Growth Chamber

Regarding the present exemplary experiments, lettuce seeds were sown in a soil mix, such as Agro mix® G6 (Fafard), in 200 cell trays for germination. After two weeks of growth, the lettuce plants were treated with either rhizosphere (around 1 ml/plant) water only (as control) or a concentration of 1% of the botanical extract. Each treatment had seven (7) replicates.

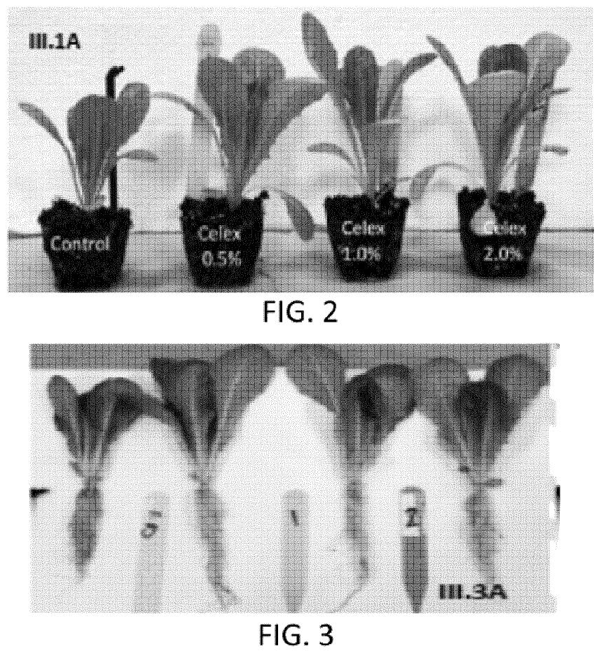

Referring now to FIGS. 2 and 3, lettuce plants grown under greenhouse conditions are shown after three (3) weeks. From left to right, the lettuce plant was treated with a control and with the respective concentrations of 0.5%, 1.0% and 2.0%. FIG. 2 illustrates the lettuce in pots and FIG. 3 illustrates the unearthed lettuce plants showing the roots.

After three weeks of growth, FIGS. 2 and 3, lettuce plants treated with the botanical extracts were healthier and taller as compared to the control (water only). Dose combinations of the botanical extract at a concentration of 0.5% and with yarrow showed healthy plants characteristics, such as but not limited to good height, green leaves, and sturdy stems (data not shown). Lettuce plants treated with the botanical extract at a concentration of 1% or 2% combined with thyme showed plants characteristics more or less similar to the plant characteristics of the control (data not shown).

TABLE 2
Chlorophyll content (μg · cm−2) of lettuce
leaves grown under greenhouse conditions

| | Lettuce Chlorophyll |
|---|---|
| Treatment | content |
| Control (H2O) | 28.56 ± 0.09 |
| Ethanol | 26.5 ± 0.707 |
| Yarrow | 30.23 ± 1.8 |
| Botannical composition 0.5% | 29.63 ± 0.80 |
| Botannical composition 1.0% | 32.2 ± 1.02 |
| Botannical composition 2.0% | 30.6 ± 0.60 |

* The above numbers represent average of four plants (two compound leaves per plant). Three separate readings per leaf were recorded.

Referring now to Table 2, the highest chlorophyll content was found in the lettuce plants treated with 1% concentration of the botanical composition with an average of 32.2 μg.cm-2.

TABLE 3
Fresh weight (FW) and dry weight (DW) of lettuce in grams

Lettuce

| Replicate/Treatment | FW (g) | DW (g) |
|---|---|---|
| Control (H2O) | 4.75 ± 0.95 | 0.37 ± 0.07 |
| Yarrow | 4.33 ± 1.15 | 0.267 ± 0.46 |
| Botannical composition 0.5% | 4.75 ± 1.70 | 0.35 ± 0.12 |
| Botannical composition 1.0% | 5.75 ± 2.36 | 0.39 ± 0.16 |
| Botannical composition 2.0% | 4.25 ± 1.25 | 0.36 ± 0.05 |

Referring now to Table 3, the concentration of 1.0% of the botanical extract gave the highest FW at 5.75 g. The total root length irrespective of the treatment was slightly higher in the botanical composition 1% compared to the control treatments as shown in below Table 4.

TABLE 4
Total length and root length (cm) of lettuce (Ave)

| | |
|---|---|
| Treatment | Lettuce |

| Length (cm) | Total | Root |
|---|---|---|
| Control (H2O) | 27.05 ± 3.7 | 14.05 ± 1.63 |
| Yarrow | 24.97 ± 2.6 | 13.23 ± 2.15 |
| Botannical composition 0.5% | 28.38 ± 2.6 | 14.93 ± 1.7 |
| Botannical composition 1.0% | 28.75 ± 2.4 | 15.7 ± 0.98 |
| Botannical composition 2.0% | 27.58 ± 4.08 | 15.2 ± 3.4 |

Regarding the present example, the botanical composition at different concentration rates showed a boosting impact on plants (i.e. lettuce and tobacco) and promoted their growth parameters. The botanical composition, amendment to Agro mix® G6 (Fafard), resulted in a positive boosting impact on plants and promoted their growth parameters. The components and molecules of the botanical composition may be interacting positively with the components of soil mixes, such as but not limited to the all-purpose soil mix Agro mix® G6 (Fafard). It may further be advantageous to use soil mixes comprising coconut husk fibers, fiber peat, perlite, limestone, gypsum and/or mycorrhiza to provide help with moistening, root growth and mineral retention. Soil amendment of the botanical composition with commercial soil mixes like Agro mix® may help in the production of healthier transplants as shown with lettuce and may further show similar results in other plants.

### B—Experiments about the Effect of the Botanical Composition on Lettuce and Tobacco Grown in Pots Under Greenhouse Conditions

In another experiment, tobacco and lettuce seeds were sown in a first soil mix, such as the Agro mix® S4, in 200 cell trays for germination. After one (1) week of growth, the seedlings were transplanted into pots (6 inches) with second soil mix, such as commercially available Agro mix® G6 (Fafard) amended with 14-14-14 TYPE 70 nutricote NPK. The soil mix used generally comprises a high porosity that provides superior drainage and gas diffusion due to the particular peat composition of the said soil mix. The transplanted seedlings where treated with one of the following treatments: water treatment, as control or a 1% concentration of the botanical composition. Each treated pot received three single doses as soil drench (10 ml/pot) at an interval of 5 days. After 4 weeks, the plants were harvested after 4 weeks. In such an experiment, all treatments were done with 7 replicates.

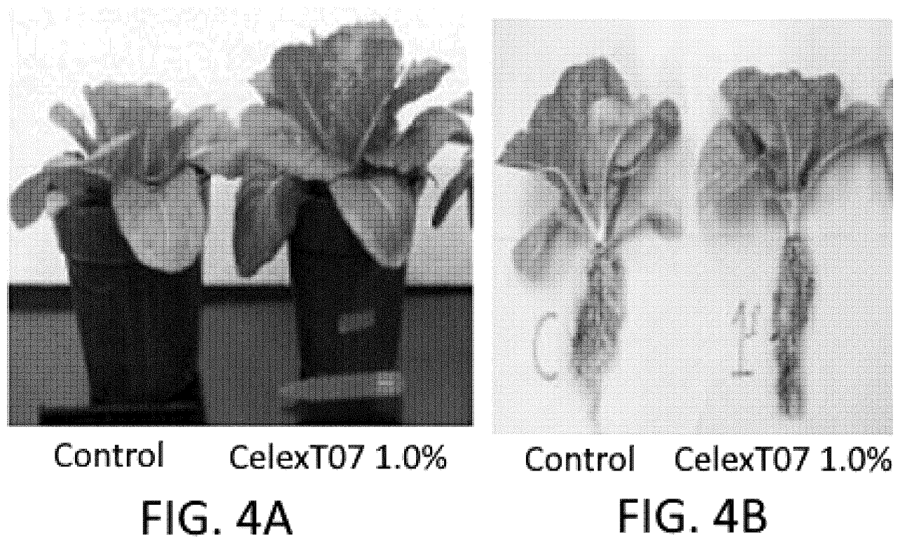

Referring now to FIGS. 4A and 4B, exemplary lettuce plants grown in single pots in the present experiments are shown in pots and out of the pots washed out of soil. The leaves of lettuce plants treated with a 1% concentration of the botanical composition alone were greener and stronger with no signs of any nutrient deficiency as compared to control, the control including the second soil mix (Agro mix® G6 alone). The fresh and dry weight of the 1% concentration treated lettuce plants was substantially higher than the plants treated with the control, as shown in FIGS. 4A and 4B and in below Table 5.

TABLE 5
Fresh & dry weights and height of lettuce plants in control treated plants

| | Botanical composition at 1% | | | Control | | |
|---|---|---|---|---|---|---|
| | Fresh | Dry | | Fresh | Dry | |
| | Weight | Weight | Height | Weight | Weight | Height |
| Treatments | (g) | (g) | (cm) | (g) | (g) | (cm) |
| Replicate 1 | 67.80 | 9.4 | 45.2 | 58.80 | 7.9 | 38.6 |
| Replicate 2 | 61.42 | 7.5 | 41 | 57.54 | 7.13 | 43.1 |
| Replicate 3 | 58.63 | 7.8 | 46.7 | 54.49 | 7.43 | 39.4 |
| Average | 62.61 ± 4.7 | 8.1 ± 1.02 | 44.3 ± 2.9 | 56.9 ± 2.2 | 7.5 ± 0.38 | 40.4 ± 2.4 |

Interestingly the chlorophyll content of the lettuce plants treated with the 1% concentration treatment was similar to the content of the lettuce plants treated with the control, as shown in below Table 6.

TABLE 6
Chlorophyll content (μg · cm−2) of lettuce plants

| Replicates | Botanical composition at 1% | Control |
|---|---|---|
| 1 | 32.2 | 32.1 |
| 2 | 33.6 | 32.0 |
| Average | 32.6 ± 0.5 | 32.1 ± 0.05 |

* The table numbers represent the average four plants (two compound leaves per plant). Three separate readings per leaf was recorded.

Based on the present experiments, the botanical composition at different concentration rates showed a boosting impact on plants (i.e. lettuce) grown in greenhouse conditions and promoted growth parameters on such plants. The botanical composition amendment to the first soil mix, such as Agro mix® G6 (Fafard), further resulted in a positive boosting impact on plants and promoted growth parameters of the same plants. Consequently, the components and the molecules of the botanical composition may positively interact with the components of the first soil mix, such as Agro mix® G6 (Fafard).

Referring to Table 5, the plants treated with the 1% botanical composition had higher fresh and dry weight and height compared to the plants treated with the control. In summary, there was 8% increase in dry weight, 10% increase in fresh weight, and 9.6% increase in height in the lettuce plants treated with the 1% botanical composition as compared to the lettuce plants treated with the control.

It may further be observed that there is no discernable difference between the chlorophyll content found in the plants treated with the 1.0% botanical composition and the control.

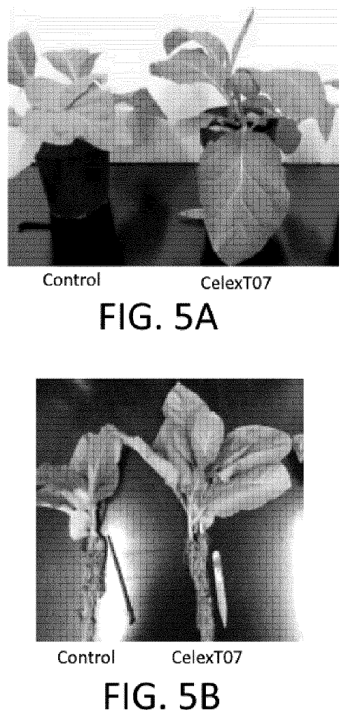

Referring now to FIGS. 5A and 5B, exemplary tobacco plants grown in single pots are shown. Referring to FIG. 5A, tobacco plants grown in single pots are shown and referring to FIG. 5B, the same plants are illustrated taken out of the pot and washed from soil. The left tobacco plant of FIGS. 5A and 5B is treated with control (only soil mix) and the right plant is treated with a 1.0% concentration of the botanical composition. The tobacco plants grown in pots in control using a soil mix only, such as Agro mix® G6,) were normal looking; tall, green and leaf size but the bottom leaves were showing deficiency signs. The tobacco plants treated with the 1% botanical composition were healthier and had more vigorous characteristics, such as being taller and greener and having much fewer pale leaves. The tobacco plants treated with the 1% composition had higher fresh weight, dry weight and height than the plants treated with the control.

TABLE 7
Fresh Weight, Dry Weight and Height of Tobacco
(Control, Botannical composition)

| | Botanical composition at 1% | | | Control | | |
|---|---|---|---|---|---|---|
| | Fresh | Dry | | Fresh | Dry | |
| | Weight | Weight | Height | Weight | Weight | Height |
| Replicate | (gm) | (gm) | (cm) | (gm) | (gm) | (cm) |
| 1 | 64.63 | 7.07 | 46 | 41.77 | 4.60 | 35 |
| 2 | 54.43 | 5.28 | 44 | 47.64 | 5.16 | 38 |
| 3 | 58.90 | 4.82 | 45 | 41.30 | 3.33 | 35 |
| Average | 55.9 ± 5.1 | 5.72 ± 1.19 | 45 ± 1 | 43.57 ± 3.5 | 4.36 ± 0.9 | 36 ± 1.7 |

* Reading in this table are average of three plants.

Referring now to Table 7, in summary, the dry weight increased by 31% increase in dry weight, the fresh weight increased by 28% and height increased 9.6% compared to the control.

TABLE 8
Chlorophyll content (μg · cm−2) of Tobacco in Control

Chlorophyll Content

| Replicate | Botanical composition at 1% | Control |
|---|---|---|
| 1 | 24.45 | 23.10 |
| 2 | 26.75 | 24.95 |
| 3 | 25.45 | 23.8 |
| Average | 25.25 ± 1.15 | 23.95 ± 0.93 |

* Note that each reading represents an average of four readings taken from two adjacent leaves of a plant.

Referring now to Table 8, the highest chlorophyll content was recorded with the 1.0% botanical composition treatment, a 5.42% increase as compared to control.

In conclusion, the botanical composition treatment at different concentration rates showed a boosting impact on plants, such as but not limited to tobacco plants, when grown in greenhouse conditions and promoted growth parameters of the said plants. When the botanical composition is combined to a soil mix, such as Agro mix® G6 (Fafard), the boosting impact on the plants further increased and such composition promoted the growth parameters of the said plants. The components and molecules of the botanical composition may be interacting positively with the components of the soil mix, such as Agro mix® G6 (Fafard).

### III—Experiments of the Botanical Composition and of the Botanical Composition Combined with Stimulagro on Germination and Early Growth of Soybean

In the present exemplary experiment, the SOP methodology was used to assess effect of different herbal treatment products, such as but not limited to C7, the botanical composition comprising C. majus extract and Stimulagro: A. (ST) nodosum extract. Stimulagro is a composition majorly made of algae. The herbal products were used individually and in combination, on germination and early growth of soybean and were compared to a water control treatment. The experiment further comprises measuring the physiological properties such as but not limited to growth characteristics, biomass, chlorophyll content and gas exchange parameters.

The experiments further comprise applying the SOP. The experiments comprise using the Rolled Towel Test by ISTA (1985) with some modifications. The ISTA method used dry seeds and moistened paper. The first modification involved soaking the seeds overnight (20-24 h) in double distilled water and using dry, pre-folded paper. In this way, the germination lag time was reduced, seeds stuck to the dry paper, and the paper was more readily rolled. The test was made on paper cut from a roll, such as a 60×20 cm paper cut (i.e. Classique Kraft brown, Servicorp, QC, Canada) and folded lengthwise, such as folded in 60×10 cm sections. Seeds were placed in a single row, such as 1 cm from the top and 5 cm apart. Seeds were held in position by folding the paper again lengthwise, to cover the seeds. The paper rectangle containing the seeds was rolled along the short axis and secured with glue or tape, such as scotch tape—Scotch® Magic™ Tape ¾″×1296″, MN, USA. The roll was placed vertically, with the seeds toward the top, inside a plastic container, such as a 1 L container, containing a proportion of the respective treatment solution, in this case, an exemplary 40 ml. The containers were kept in a growth chamber at predetermined conditions, such as a Conviron® environmental chamber, Winnipeg, Canada set at 16:8 h light:dark cycle with 25±2° C. temperature, 400 μM m-2 s-1 flux density of cool white and incandescent lights and 50% relative humidity. Paper towels were never allowed to dry out. Each morning, residual medium was discarded, and the same proportion (i.e. 40 ml) of fresh treatment solution was added. Germination was monitored daily. Growth (shoot length, shoot fresh and dry mass) chlorophyll content and photosynthetic rate were tested with fifteen days old seedlings.

Photosynthesis measurement: Photosynthetic rate, such as μmol m-2 s-1 CO2, was measured using a portable infra-red gas analyzer, such as IRGA-LI-6400, LI-COR Inc., Lincoln, Neb., USA. Measurement was performed on separate areas of soybean plant leaves, such as fully expanded unifoliate for seed treatments and fully expanded third trifoliate leaf for foliar applications. In such experiments, the infra-red gas analyzer (i.e. IRGA) was calibrated and zero-adjusted approx. every 30 min during the measurement period.

Chlorophyll content measurement: Leaf chlorophyll content of fully expanded leaves was estimated using a SPAD 502 meter, such as a Konica Minolta Optics, Inc., New Jersey, U.S.A., by averaging 10 readings per treatment. The results are shown in Soil Plant Analysis Development (SPAD) units.

Germination, growth characteristics and biomass measurements: Germination was monitored daily. Plant height was measured from the basal node to the shoot apex using a ruler. In an exemplary measurement process, fresh (FM) and dry (DM) shoot mass were taken on three randomly selected plants/roll (6 plants/replicate) and weighed on an analytical balance, such as Highland® balance, Adam Equipment Inc., Oxford, Conn., USA. Also, shoots were harvested just above the paper towel for FM then dried at exemplary 60° C. for 72 h and weighed for DM.

### Experimental Design and Statistical Analysis

The experimental design was a completely randomized design (CRD). In such exemplary design, the CRD comprises 5 replicates of 20 seeds each, with 10 seeds per roll and 2 rolls per container. Data was expressed as means±standard error of the mean (SEM) and analysis of variance, such as 1-way ANOVA, was followed by post hoc Newman-Keuls Multiple Comparison Test, such as using a software GraphPad Prism version 5.01, 2007, Graf Pad Software, Inc., CA, USA. In the exemplary design, the level of significance was *P<0.05.

The treatment of soybean seeds with the 1% botanical composition alone leads to a statistically significant increase in dry weight, such as an exemplary 12.9%. Additionally, results show that the seed treatment of soybean with the combination of both the botanical composition and Stimulagro generally leads to positive enhancements in the physiological properties of the treated soybean. Amongst other treatments, the treatment with the 1% botanical composition combined to Stimulagro was observed as the most beneficial treatment. The said treatment significantly (P<0.05) increased soybean seedling (in this case 2 weeks old) shoot height (i.e. 13.2%), dry mass (i.e. 10.7%) and rate of photosynthesis (i.e. 20.3%) compared with water control (see exemplary results at Table 9).

TABLE 9
Effect of the botanical composition (C7), Stimulagro (ST), and combination of the botanical composition
and Stimulagro on plant height, fresh and dry weight, SPAD units, and photosynthetic rate of soybean.

| | | | | | | | | | Photosynthetic | |
|---|---|---|---|---|---|---|---|---|---|---|
| | Plant height | | Fresh weight | | Dry weight | | | | rate (μmol m⁻²s⁻¹ | |
| | (cm) | | (g) | | (g) | | SPAD units | | CO₂) | |
| | | % diff. | | % diff. | | % diff. | | % diff. | | % diff. |
| Control | 22.7 | | 1.02 | | 0.31 | | 33.4 | | 7.31 | |
| (H₂O) | | | | | | | | | | |
| 0.5 g/L | 23.10 | (+1.8) | 1.08 | (+5.9) | 0.31 | (0.0) | 33.60 | (+0.6) | 7.58 | (+3.7) |
| C7 | | | | | | | | | | |
| 1.0 g/L | 24.50 | (+7.9) | 1.12 | (+9.8) | 0.35* | (+12.9) | 33.50 | (+0.3) | 7.92 | (+8.3) |
| C7 | | | | | | | | | | |
| 2.0 g/L | 24.30 | (+7.0) | 1.11 | (+8.8) | 0.32 | (+3.2) | 33.60 | (+0.6) | 7.31 | (0.0) |
| C7 | | | | | | | | | | |
| 0.5 g/L | 25.30 | (+11.5) | 1.13 | (+10.8) | 0.35* | (+12.9) | 34.20 | (+2.4) | 7.89 | (+7.9) |
| ST | | | | | | | | | | |
| 1.0 g/L | 24.20 | (+6.6) | 1.12 | (+9.8) | 0.32 | (+3.2) | 34.60 | (+3.6) | 7.82 | (+7.0) |
| ST | | | | | | | | | | |
| 2.0 g/L | 24.10 | (+6.2) | 1.10 | (+7.8) | 0.32 | (+3.2) | 34.20 | (+2.4) | 7.60 | (+4.0) |
| ST | | | | | | | | | | |
| 0.5 g/L | 24.20 | (+6.6) | 1.10 | (+7.8) | 0.33 | (+6.5) | 34.60 | (+3.6) | 8.27 | (+13.1) |
| C7 + ST | | | | | | | | | | |
| 1.0 g/L | 25.70* | (+13.2) | 1.13 | (+10.8) | 0.36* | (+16.1) | 35.10 | (+5.1) | 8.80* | (+20.4) |
| C7 + ST | | | | | | | | | | |
| 2.0 g/L | 24.90 | (+9.7) | 1.08 | (+5.9) | 0.32 | (+3.2) | 35.20 | (+5.4) | 8.68 | (+18.7) |
| C7 + ST | | | | | | | | | | |

As seen in Table 9, the results clearly show an enhancement of physiological properties, growth parameters and rate of photosynthesis of soybean when treated with the botanical composition combined with Stimulagro.

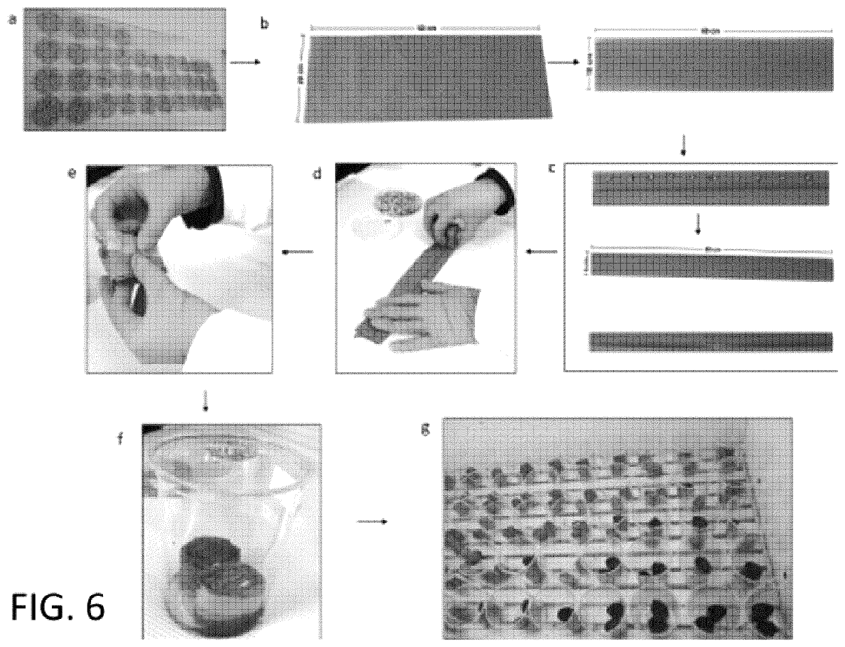

The results further underlined the discriminatory value of SOP-soybean and the potential of one herbal extract treatment in particular as a growth stimulant for soybean, as shown in FIG. 6. SOP is used for the germination and growth of soybean for analyzing the impact of the botanical composition and of the combination of the botanical composition and Stimulagro on the germination and early growth of soybean. Still referring to FIG. 6, a modified version of the rolled paper towel test developed by the International Seed Testing Association (ISTA, 1985) is also shown.

The protocol followed (SOP-Soybean) is summarized as follows:
SOP developed for analysis of the impact of herbal extracts on germination and early growth of soybean (SOP-Soybean).
Modified the rolled paper towel test developed by the International Seed Testing Association (ISTA, 1985).

Referring to FIG. 6, the protocol comprises:

a) Soaking soybean seeds for a predetermined period, such as overnight (20 h), before performing the assay.

b) Folding an absorbent material in half lengthwise, such as a paper towel (i.e. 60 cm×20 cm).

c) Placing a predetermined number of pre pre-soaked seeds (i.e. 10) in single rows, such as placed 1 cm from the top, in a single row 5 cm apart, leaving 5 cm at each end.

d) Holding the seeds in place by positioning pre pre-folded paper over the seeds.

e) Folding a second time the absorbent material, such as of 1 cm, to strengthen the base of the roll.

f) Quickly rolling the dry paper containing the seeds lengthwise and securing the said paper with tape.

g) Placing vertically the rolls in a transparent container with a predetermined volume of treatment solution, such as 40 ml.

h) Maintaining the containers under defined conditions in a growth chamber, such as maintaining at 25±2° C. and 16:8 h day:night cycle with 400 μM m m-2 s-1 flux density.

i) Adding the predetermined volume of fresh treatment solution daily, such as 40 ml.

The present protocol generally aims at providing the following advantages:
Efficient method to test the effect of potential growth stimulants on seed germination and early growth.
Rapid testing (i.e. 2 weeks duration) and space efficient.
Repeatable; performed under defined growing conditions.
Relatively simple and low low-cost method that can be performed in industry by staff with minimal training and easily available materials.

### IV. Experiment Evaluating Efficacy of the Botanical Extract in Yield Improvements in Potted Cannabis

The present experiment was conducted using “Candyland” hybrid cultivar. In order to identify or screen biostimulant properties and the effects on bloom and yield, a licensed patient grower having enough material to conduct the pilot trial was used.

The experiment comprises testing several concentrations, from 0.03 to 2%, of the botanical extract on Cannabis plants to evaluate the effects on bud size and yield. The same strain sharing the same genetics was used in the test. The total number of plants tested was 120. A total of 60 plants were used for the botannical compositiontreated group and 60 plants for the untreated control group. Treated plants were compared to control plants and both were grown hydroponically under conventional home greenhouse conditions. Either foliar, root drench or a combination of foliar and soil-drench were applied to the plants.

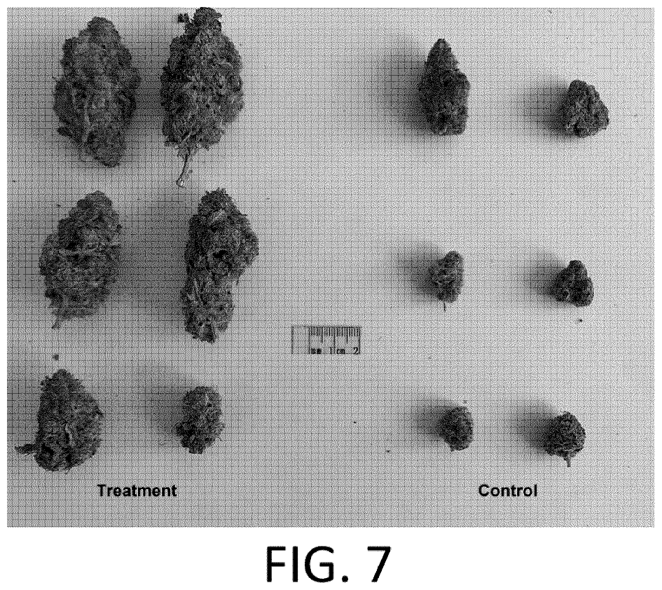

For testing the biostimulant effects, different treatments ranging from 0.03 to 2% of the botanical composition where used, such as root drench alone or root-drench combined to foliar application, with a total of 4 to 30 applications. The experimental treatments led to healthier crops and to a substantial boost and increase in the yield and size of the Cannabis flowers as shown in FIG. 7. FIG. 7 shows, on the left, the result of a treatment of buds of Cannabis sativa plants treated with 0.03 to 2% of the botanical composition in addition to the conventional fertilization and management regime. On the right, FIG. 7 shows the result of buds of Cannabis sativa plants which received only the conventional fertilization/management regime. In the present experiment, total yield was improved by 25% in plants treated with the botanical extract when compared to the control treated plants. Similar plant strains with the same genetics were used in the test for both the control and the treatment.

### The Botanical Composition as a Biofungicide

According to another embodiment, the botanical composition may further be used as a biofungicide and thus help treat or stop the spread of diseases on plants.

### I—Foliar Treatment of Lettuce Leaves Treated with the Botanical Composition Alone or in Combination with Yarrow Leads to Treat or Suppress Botrytis cinerea

In a first test, Botrytis cinerea plugs (5 mm) were placed on detached leaves of treated plants (single dose of the botanical composition or a combined dose of the botanical composition with yarrow (Y)) as well as control (water). Leaves were kept in trays with wet filter paper, such as Pyrex trays. The treated leaves were observed every day. The lettuce leaves infection results were recorded 72 hrs later.

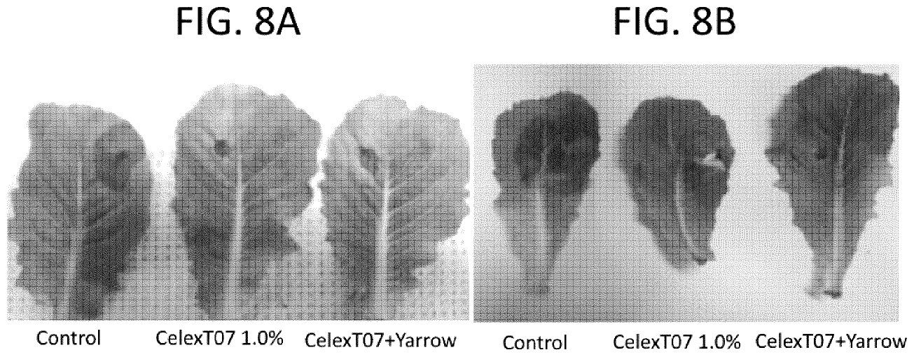

Referring now FIG. 8 and Table 10, two trials of lettuce leaf infected with Botrytis plugs and treated as described above are shown, one on the left and the other on the right. The lettuce leaves necrotic lesion diameter was higher on plants treated with the control and was lower on plants treated with botanical composition alone.

TABLE 10
Diameter of necrosis for lettuce treated with 1% of
the botanical composition or with water control

| | Necrosis diameter of lettuce |
|---|---|
| Treatment | (cm) |
| Control | 2.28 cm ± 1.16 |
| Botannical composition (1.0%) | 0.6 cm ± 0.07 |
| Botannical composition (1.0%) + | 1.4 cm ± 0.28 |
| Yarrow 50:50 | |

* Necrosis diameter is the average reading from ten leaves

### II—Greenhouse Trials Evaluating the Efficacy of the Botanical Extracts in Disease Suppression of Grey Mold on Tomato and Lettuce

In an exemplary trial, organic tomato and lettuce seeds were germinated in a soil mix, such as Agro mix® S4 (Fafard), in predetermined number of cell trays, such as 20. After 2 weeks of growth, seedlings were transplanted into pots, such as pots having 6 inches diameter in another soil mix, such as Agromix G6 (Fafard) amended with 14-14-14 TYPE 70 nutricote NPK. Pots were placed in randomized block design (RBD) in standard greenhouse growing conditions and irrigated with an automated system. All trials were repeated twice. The appropriate data of repeated trials was pooled.

To determine whether the botanical composition can suppress disease, the botanical composition at 1% was applied using different methods: first being soil drenching and second being leaf dipping.

### Soil Drenching

In a first method of treatment, 4 weeks old potted plants received, as soil drench treatment, a single dose of 1% of botanical composition, such as 10 ml or 20 ml, repeated every at a frequency, such as 24 hours for 96 hours. Control treatments instead received water. The treatments (8 in total) were applied to the soil close to the plant using different amounts as shown in Table 11. After 24 hours post-treatment of the botanical composition, detached leaves and leaves still attached to the plants were challenged with Botrytis cinerea. Furthermore, different concentrations of the botanical composition were applied as a soil drench to check for its role in disease suppression during Grey mold disease development.

### Disease Inoculation

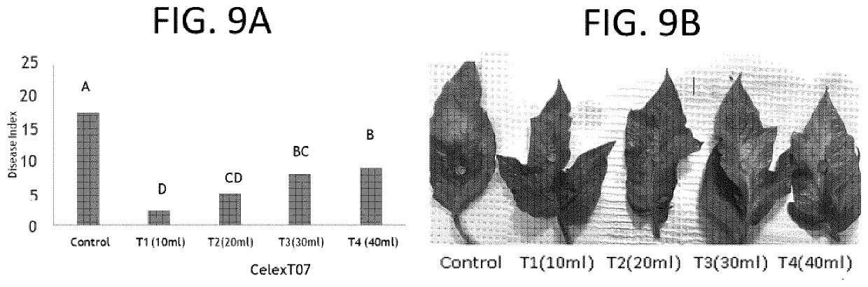

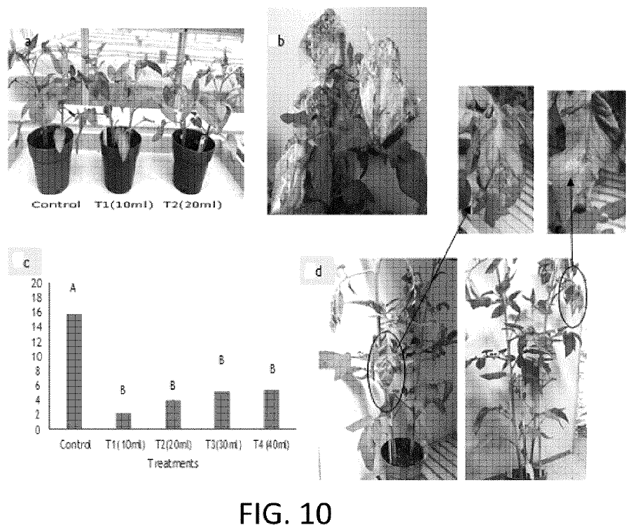

Fungal mycelial plugs from freshly grown Botrytis fungus were placed on uniform leaves of soil drenched plants and treated with the botanical composition or treated with a water-based control. The infected leaves were covered with moist plastic bags to create a humidity tent over it, as seen in FIGS. 9B and 10. The plants were placed in a separate humid growth chamber and infection was recorded after 72 hours.

### Disease Measurement

A disease index was recorded after 72 hours of inoculation for detached leaves and for non-detached leaves. Disease index was measured as ratio of necrotic lesion area to healthy tissue area using a rendering software, such as ImageJ, following the instructions of Haliem (2012); and Steward and Macdonald (2014), and recorded as percentage. All treatments were performed with 10 replicates and the trial was repeated twice. Collected data were averaged and differences between treatments were analyzed using JMP11 (SAS-one-way ANOVA, Tukey HSD, α 0.05) and significance between treatments was indicated.

### Detached Leaves

Plants receiving repeated doses of 10 ml or a single dose of 20 ml of the botanical composition 1%, see for instance T1 to T5 of below Table 11, successfully reduced lesion areas as compared to control treatment. A disease index of detached leaves of soil drenched healthy plants treated with water (control) and the botanical composition and post-infected with B. cinerea plants, from 10 ml to 40 ml, is shown in FIG. 9A. Values of FIG. 9A are the average of 10 leaves per treatment. Furthermore, FIG. 9B shows the necrotic lesions of plants treated with control and different amounts of the botanical composition. A single dose of 10 ml of the 1% e botanical composition, see 1%, treatment T1 at Table 11, significantly (P<0.05) reduced necrotic lesions by 84%, with an average necrotic lesions area of 2% as compared to the control treatment having >15% of the leaf tissue with necrotic lesions, seen in FIGS. 9A and B. Additionally, repeated doses of 10 ml, treatments T2, T3 and T4 in Table 11, were significantly effective in reducing the lesion areas as compared to the control without being significantly different from each other.

### Non-Detached Leaves

Infection on non-detached leaves of soil-drenched plants was significantly reduced as a result of the botanical composition soil drench treatment seen in FIG. 10 and was more effective compared to in vitro detached leaves as seen from FIGS. 9A and 9B. Referring now to FIG. 10, the method of a soil drenched treatment and the results of the said method are illustrated. Respectively, at step A, tomato plants are soil drenched in pots. At step B, a humidity tent is installed over infected tomato leaves. At step C, a disease index is made which shows the number of infected and attached tomato leaves for control and treated for a range of 10 ml to 40 ml, plants. At step D, B. cinerea on leaves of tomato plants from control and treated with the botanical composition at 1.0% are shown. Compared to control treatment, the disease index decreased by almost 90%. The disease index was significantly lower for all of the four treatments, namely T1 to T4 shown in Table 11.

TABLE 11
Soil drench treatments of the botanical
compo applied to the tomato plants

| | | | | | Total amount |
|---|---|---|---|---|---|
| Treatments | | | | | of botannical |
| (1% Botannical | | | | | composition |
| composition) | Day 1 | Day 2 | Day 3 | Day 4 | plant received |
| Treatment | 10 | | | | 10 |
| 1 (ml/pot) T1 | | | | | |
| Treatment | 10 | 10 | | | 20 |
| 2(ml/pot) T2 | | | | | |
| Treatment | 10 | 10 | 10 | | 30 |
| 3(ml/pot) T3 | | | | | |
| Treatment | 10 | 10 | 10 | 10 | 40 |
| 4(ml/pot) T4 | | | | | |
| Treatment | 20 | | | | 20 |
| 5(ml/pot) T5 | | | | | |
| Treatment | 20 | 20 | | | 40 |
| 6 (ml/pot) T6 | | | | | |
| Treatment | 20 | 20 | 20 | | 60 |
| 7(ml/pot) T7 | | | | | |
| Treatment | 20 | 20 | 20 | 20 | 80 |
| 8(ml/pot) T8 | | | | | |

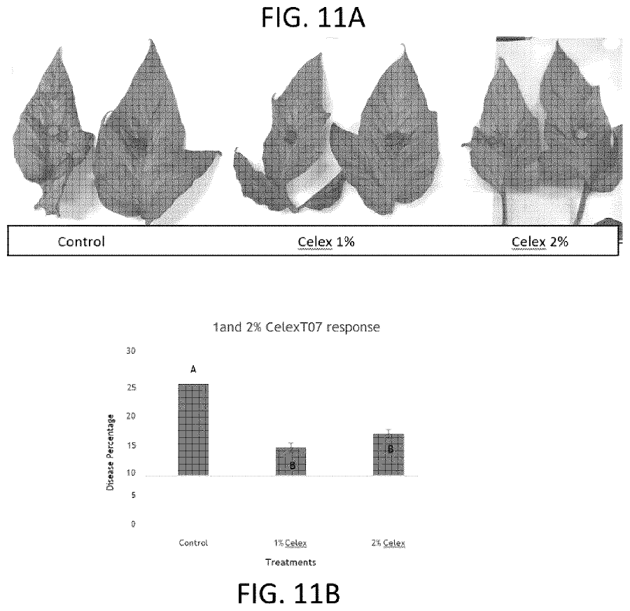

Soil drench applications of the botanical composition at concentrations of 1% and 2% showed effective suppression of Grey mold disease on tomato during disease progression. The botanical composition at concentrations of 1% and 2% were found significantly effective in inhibiting disease on tomato leaves compared to the control plants. More so, the botanical composition at 1% was determined as being more effective than the botanical composition at 2% concentration. Referring now to FIG. 11A, tomato plants treated with the botanical composition by soil drench. From left to right, control, the botanical composition at 1.0% and the botanical composition at concentration of 2.0%.

Referring now to FIG. 11B, a disease index for tomato plants treated with the botanical composition by soil drench are illustrated.

In another embodiment, the addition of the botanical composition to a soil mix, such as Agro mix® G6 (Fafard), enables tomato plants to become resistant to Botrytis cinerea, the causal agent of grey mold disease. The components and molecules of the botanical composition may be interacting positively with the components of the soil mix, such as Agro mix® G6 (Fafard), the resulting in inducing resistance in the plants, such as tomato plants, against disease. Thus, the botannical compositionamendment into Agro mix® G6 (Fafard) resulted in the suppression of Grey mold disease on tomato plants.

### Leaf-Dip Method

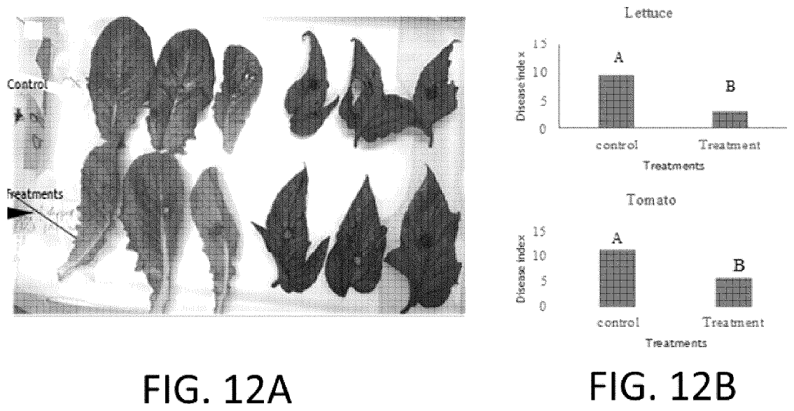

The second method of treatment comprises detaching uniform size tomato and lettuce leaves and submerging said detached leaves in 1% botanical composition for a predetermined duration, such as 30 seconds. The method further comprises placing the submerged leaves in plates, such as Pyrex plates, lined with moist filter paper. The method further comprises dipping control leaves dipped in water. The method further comprises placing B. cinerea plugs of an actively grown culture on detached leaves of control and of plants treated with the botanical composition. The trays are sealed, such as sealed using a wrapping means (i.e. Saran wrap) and incubated at room temperature, as shown in FIG. 12A. Disease index was recorded after 72 hours of incubation.

Referring to FIG. 12A, lettuce leaves on the left and tomato leaves on the right are shown. In such exemplary experiment, the bottom row was dipped, or in some cases submerged, in the 1% botanical composition and challenged with B. cinerea wherein the top row was dipped in the water-based control. Referring now to FIG. 12B, the disease index is shown as graphics. In such example, the disease index was calculated based on 10 biological replicates. Significant disease reduction was observed in lettuce with 33% reduction and up to 45% in tomato treated with the botanical composition as compared to the control treatment.

### III. Efficacy of the Plant Extract Botanical Composition in Suppression of Fungal Diseases on Cannabis and Hops Growth Under Greenhouse Production Systems

### 1. Bioactivity of Botanical Extract Composition In Hops (Humulus lupulus): Phytotoxicity Test on Detached Leaves of Hops Following Foliar Application

In yet another exemplary experiment, hops rhizomes, of the variety Willamette, were obtained. The experiment method comprises transplanting Rhizome cuttings into pots in a soil mix. As an example, the pots were 6 inches and the soil mix was Agromix G6 (Fafard). The experiment method further comprises placing in growth chambers in predetermined conditions, such as with 12/12 h of day/night, 23/21° C. day/night temperatures, 210 photons μm⁻²s⁻¹, and humidity maintained at 65% throughout the entire day.

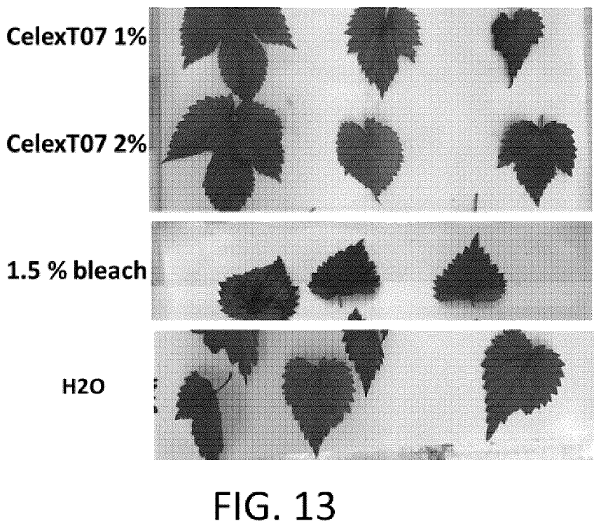

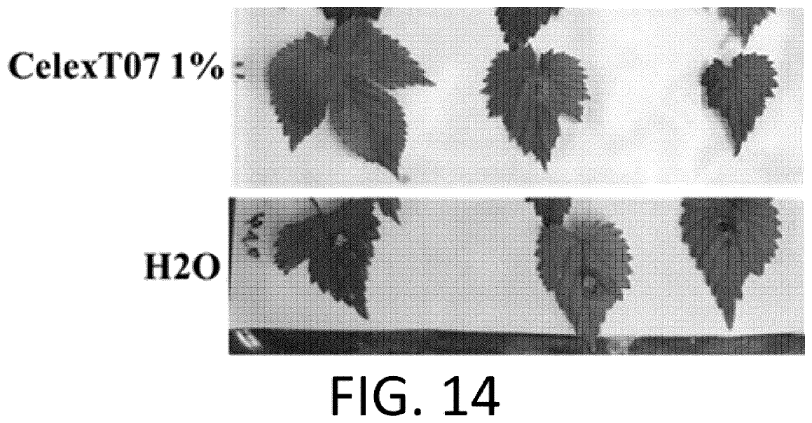

The experiment method further comprises detaching the hops leaves from two months old plants and placing the detached leaves in plates lined with wet filter papers, such as Pyrex® plates. Referring now to FIG. 13, the method further comprises dipping the leaves in different concentrations of the botanical composition, such as 3-ml of the botanical composition. In such an experiment, three leaves from three different plants were used per treatment and incubated at room temperature. The control treatments comprise 1.5% Bleach as positive and water as negative controls.

Phytotoxicity occurs when a plant is exposed to an external factor that is toxic to the plant and symptoms may occur when leaf margin necrosis and browning, yellowing (chlorosis), yellow or brown or black spots (see, for instance, Kristin Getter, Michigan State University Extension, Department of Horticulture). The concentration of botanical composition was considered to be phytotoxic if treated leaves showed any of the previous symptoms when compared to the water treatment.

Still referring to FIG. 13, the phytotoxic response, two days post treatment, of detached hops leaves treated with the botanical composition is shown. The leaves were immersed in a predetermined volume (i.e. 3 ml) of two different concentrations of the botanical composition or in the same predetermined volume (i.e. 3 ml) of bleach or water (control). The experiment further comprises coating the detached leaves with the treatment 1% and 2% of the botanical composition. The coating did not create or produce any phytotoxicity on hops. Hence, foliar application of the botanical composition, from 0.2% up to 2%, are believed to be safe when used commercially in greenhouse growth conditions.

### Fungicidal Activity of the Botanical Composition Against Grey Mold Following Foliar Application

In still another experiment, two months old leaves from hops plants were detached and immersed in 3 ml of a respective treatment (various concentrations of the botannical composition) and placed Pyrex plates lined with wet filter papers for 24 hours. There were three leaves per treatment. Shown in FIG. 14, leaves were inoculated in their center with an agar plug containing a one week old actively growing colony of Botrytis cinerea. Plates were incubated at room temp for 48 hours. Control treatments consisted of leaves treated with water only. Further in FIG. 14, the top leaves were treated with 1% concentration of the botannical composition wherein the bottom leaves were treated with water with B. cinerea. It can be observed that single foliar application of the botannical composition at 1% caused disease suppression of grey mold on hops.

### Phytotoxicity Test on Detached Leaves of Hops Following Soil Drench Application

The aim of this experiment was to test for phytotoxic effect on potted plants, hops grown in Agromix G6 (Fafard), and leaves when the the botanical composition is soil drenched and applied as single dose or as split dose over a predetermined period of time. In this experiment, in such experiment, the period of time was three consecutive days.

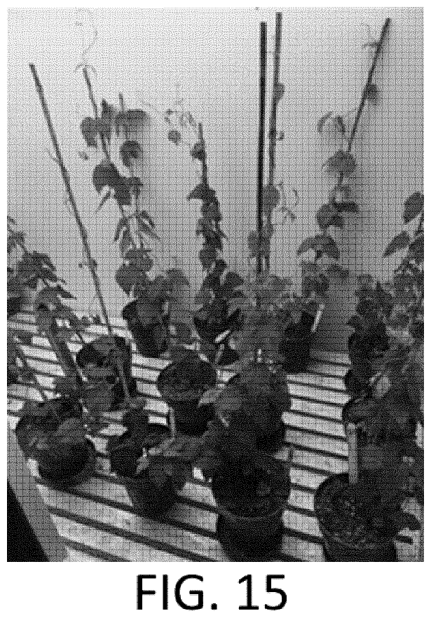

Two months old hops plants, shown in FIG. 15, were treated with either water alone or a 1% concentration botanical composition. The applied botanicals were delivered by pipetting the required amount, such as 3-cm deep around the crown area of each plant, as shown in Table 12. Each treatment consisted of two potted plants. Phytotoxic symptoms were observed after 24 hours of treatment on a total of 6 leaves per treatment.

TABLE 12
Soil drench treatments of botanicals applied to hops plants

| | | | | Total volume |
|---|---|---|---|---|
| | | | | of botanical |
| | Volume (ml/pot)/day | | | composition or |
| Application/pot | Day 1 | Day 2 | Day 3 | combined dose |
| Control: Water | 20 | 30 | 20 | 70 |
| T4 (1% botanical | 10 | 10 | 10 | 30 |
| composition in dH₂O) | | | | |
| T5 (1% botanical | 20 | 20 | | 40 |
| composition in dH₂O) | | | | |
| T6 (1% botanical | 20 | 30 | 20 | 70 |
| composition in dH₂O) | | | | |

* Each treatment of Table 12 consisted of 6 leaves.

The botanical composition at a 1% concentration singularly or combined, doses, see T4 to T6 treatments in Table 12, did not cause any phytotoxicity on hops. In fact, a split dose application of the botanicals generally helped in having no harmful effects on plants.

### Fungicidal Activity of the Botanical Composition Against Grey Mold Following Soil Drench Application

In another experiment, the experiment comprises challenging post treatment hops plants with the fungal pathogen: B. cinerea in-vitro.

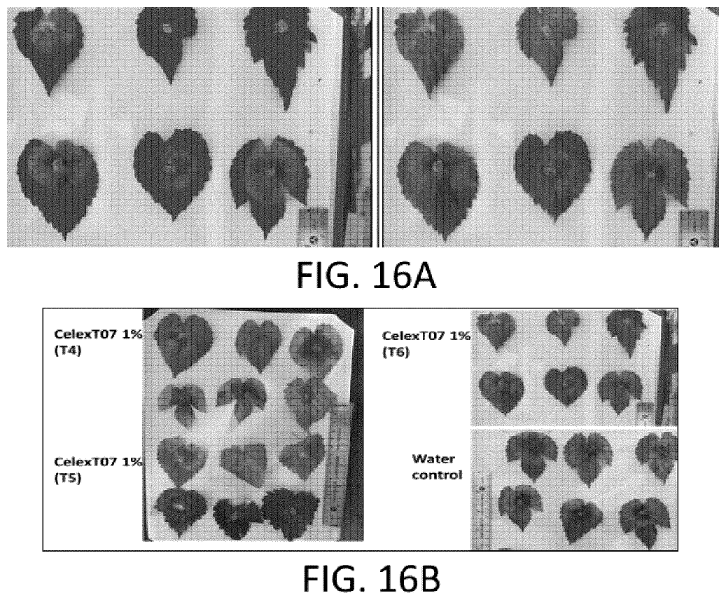

In such exemplary experiment, six uniform-sized leaves were detached from treated and control plants grown in a soil mix, such as Agromix G6 (Fafard). The experiment further comprises inoculating the detached leaves with agar plugs (i.e. 5 mm plugs) containing Botrytis cinerea being placed in the center of the detached leaves. The experiment further comprises placing the infected leaves in the trays with moist filter paper at the bottom of the tray, as seen in FIG. 16A. The placed infected leaved are then incubated at room temperature for specific period, such as 5 days. The experiment further comprises controlling the leaves. The control treatments include treating leaves with water only. The experiment may further comprise assessing the disease severity using a computer program. In such an experiment, the software ImageJ was used to score or map the severity, also shown in FIG. 16A (Haliem, 2012; Steward and Macdonald, 2014). In such an experiment, the disease severity was defined as the percentage of area infected compared to the total leaf area.

### Statistical Analysis

The statistical analysis of the results may comprise averaging the data and analyzing the differences between treatment and control by two-way analysis of variance (ANOVA), and when necessary, by least significant differences (LSD) at P<0.05 using the SPSS statistical package v. 22.0, (IBM Corp., Armonk, N.Y., USA).

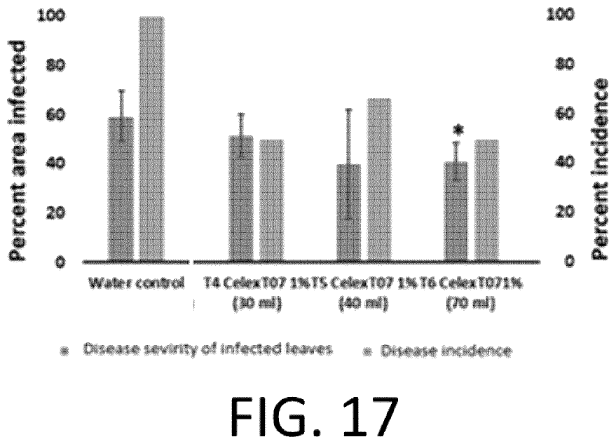

The plants soil drenched with water only (Control Treatment) and the plants soil drenched in an application of the botanical composition at 1% were compared. The treatment included three doses over three consecutive days (T6, Day 1=20, Day 2=30, Day 3=20). The comparison resulted in a significant decrease of the percentage of disease incidence and disease severity by respectively 50% and 31%, as seen in FIGS. 16B, 17 and below Table 13. Referring now to FIG. 17, the percentage area of infected detached hops leaves from control and treated plants is shown. Disease severity was calculated for infected leaves only (area of infected leaf/total leaf area). Disease incidence was calculated for the six leaves (number of infected leaves/total number of leaves). The “*” indicates a significant difference between treatment and water control using least significant difference (LSD) test (P<0.05).

TABLE 13
Disease severity % decrease during infection of hops
plants treated with botanicals using the soil drench
method in comparison to the water control treatment

| | | % Disease | | % Disease |
|---|---|---|---|---|
| | % Disease | severity | % Disease | incidence |
| Treatment | severity | decrease | incidence | decrease |
| Water control | 59.4 | — | 100 | 0 |
| T4 Botanical | 51.4 | 13 | 50 | 50 |
| composition | | | | |
| 1% (30 ml) | | | | |
| T5 Botanical | 40.0 | 33 | 67 | 33 |
| composition | | | | |
| 1% (40 ml) | | | | |
| T6 Botanical | 40.8* | 31 | 50 | 50 |
| composition | | | | |
| 1% (70 ml) | | | | |

* indicates significant difference between treatment and water control using least significant difference (LSD) test (P < 0.05)

### 1. Bioactivity of the Botanical Composition Extract in Cannabis

In another embodiment, exemplary concentrations of botanical were used on Cannabis seedlings.

### Phytotoxicity Test on Detached Leaves of Hops Following Foliar Application

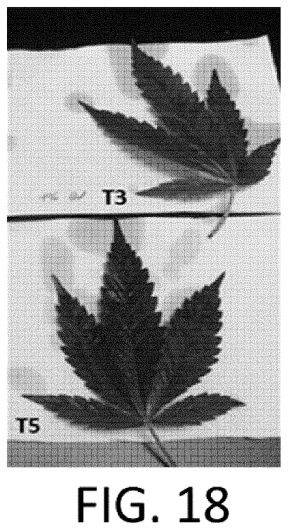

In another exemplary experiment, the experiment comprises detaching Cannabis leaves from plants grown for a specific duration, such as four months. The experiment further comprises treating the detached leaves by dipping the said leaves (i.e. 6 leaves per treatment) in the following concentration of the botanical composition: T3 at 1% and T5 for water treatment, as seen in FIG. 18. The experiment further comprises placing the leaves in plates, such as Pyrex® plates, lined with wet filter papers and incubated at room temperature. Referring now to FIG. 16, the leaves are shown after six days of the abovementioned treatment.

Based on the present experiment, a single dose of the botanical composition (T3) did not cause any phytotoxic effect on Cannabis.

### Trial I: Efficacy of the Botanical Composition in Preventing Powdery Mildew Disease on Cannabis-Foliar Application

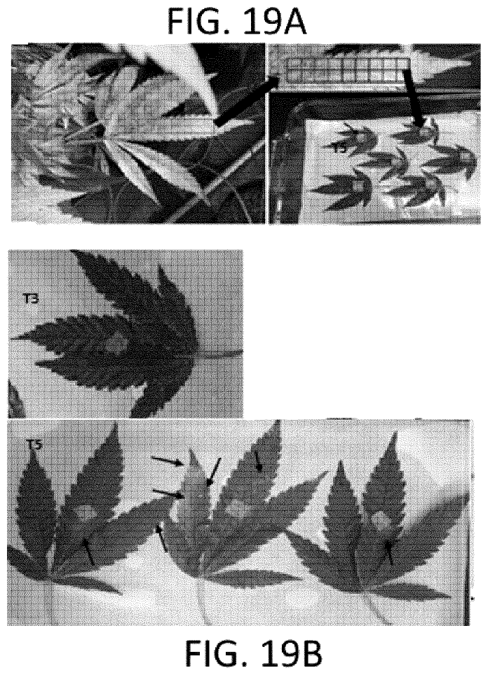

The trial I comprises using detached Cannabis leaves. The same leaves that were already dipped in different treatments, T3 and T5, were used (see above). Powdery mildew (PM) inoculum comprises pieces of leaves (such as 1 cm² pieces) uniformly infected with PM conidia. Each of the leaf pieces was in the center of the botanical composition-treated (T3) or water treated (T5) leaves, as shown in FIG. 19A. The trial further comprises incubating the plates at room temperature and monitoring the progression of the disease over time, such as during 8 days post-inoculation. The trial further comprises assessing the disease severity and the effectiveness of the treatment by comparing the results to the control treatments T5 which is water only.

Preliminary results from trial I on Cannabis demonstrated that the botanical composition 1% alone (T3) prevented disease progression of powdery mildew (PM) and retained leaves green and healthy. Signs of infection were only observed on the water treated leaves of FIGS. 19A and 19B. FIG. 19B shows the leaves after post-inoculation (8-days) and arrows indicate signs or symptoms of infection. Since the trial I was a preliminary screening experiment, another trial, Trial II, was conducted to confirm the present results and to extend the experiments to include different Cannabis varieties that exhibit different levels of susceptibility to powdery mildew.

### Trial II: Efficacy of the Botanical Composition in Preventing Powdery Mildew Disease on Three Varieties of Cannabis-Foliar Application

This trial II was conducted with two biological replications using detached Cannabis leaves of three varieties that are known for their differential susceptibility to powdery mildew (PM). The varieties were: variety I (susceptible), variety II (susceptible) and variety III (highly susceptible). Each variety was treated with a combined dose of 1% of the botanical composition with thymol and was compared to control treatments comprising water only. The trial II comprises detaching the leaves of each of the varieties and immersing the said detached leaves in combined doses of 1% botanical composition with thymol or in doses of water (control). In the present trial II, each treatment was executed on five (5) Cannabis leaves and the experiment was repeated twice. The trial II further comprises inoculating leaves with pieces of infected leaves (such as 1 cm²). Each of the pieces comprises Powdery mildew as previously described in trial I. The trial II uses two x pieces of leaves instead of the one piece of leaves used in trial I. The trial II further comprises incubating the plates at room temperature and monitoring the disease progression over time.

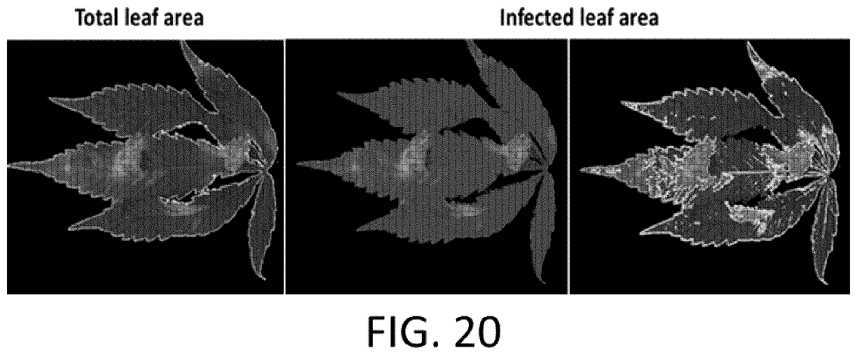

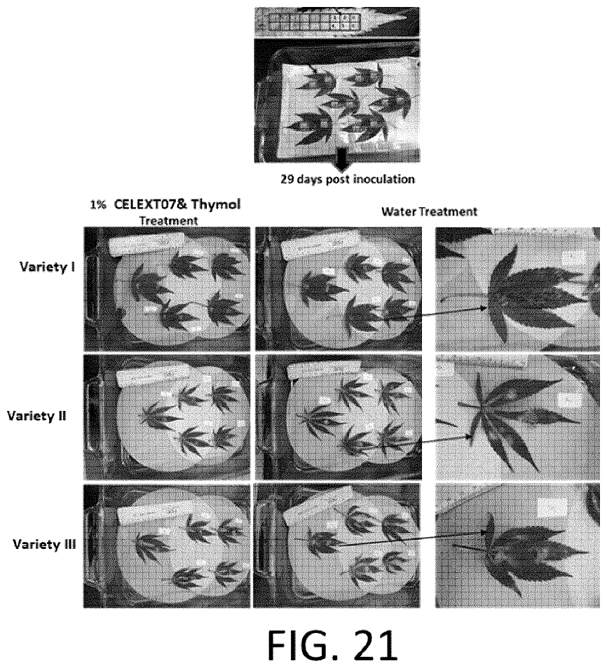

The trial II comprises recording or collecting the disease severity measurements during a determined period, such as 29 days, post-infection (DPI). Disease severity was scored using a computer program, such as the software ImageJ, as shown in FIG. 20. Disease severity is defined as the proportion (%) of area infected compared to the total leaf area. In the present trial II, disease incidence was recorded or collected at 12, 18, 26, and 29 DPI. The analysis further comprises averaging the collected data and analyzing the differences between treatment and control, the exemplary analysis using a two-way analysis of variance (ANOVA), and when necessary by least significant differences (LSD) at P<0.05 using the SPSS statistical package v. 22.0, (IBM Corp., Armonk, N.Y., USA).

The trial II is believed to successfully establish presence of the PM disease and the progression of said PM disease. The trial II further established that the presence and progression of the disease is due to the presence of two sources of inoculum and to longer incubation time, as such are believed to help in effective disease spread and successful infection, as seen in FIG. 21.

Referring to Table 14, at 12 DPI, the percentage of disease incidence was higher in the water treated leaves, from 60 to 80%, compared to leaves treated with the combined dose of the botanical composition at 1% with thymol (20%). At 26 DPI and higher, most of the leaves, except for the variety Sachigo, showed signs of disease, incidence reached almost 100%, for both water control and the botanical treatment. The disease severity was always less in leaves treated with the botanical composition at a 1% concentration combined to thymol.

TABLE 14
Effect of botanicals on disease progression and severity of Powdery mildew
on three Cannabis varieties at different DPI treated with the botannical
composition at 1% concentration and thymol using the foliar application
method in comparison to the water control treatment. DPI: day post

| | | | | | | % Disease |
|---|---|---|---|---|---|---|
| | % | % | % | % | % Disease | severity |
| | Incidence^{$} | Incidence | Incidence | Incidence | severity | decrease^{λ} |
| Variety | 12 DPI | 18 DPI | 26 DPI | 29 DPI | 29 DPI | 29 DPI |
| Variety I | 80 | 100 | 100 | 100 | 7.9 | — |
| control* | | | | | | |
| Variety I | 20 | 80 | 100 | 100 | 1.4 | 82 |
| treatment^{#} | | | | | | |
| Variety II | 60 | 80 | 100 | 100 | 13.9 | — |
| control | | | | | | |
| Variety II | 20 | 60 | 60 | 100 | 2.8 | 80 |
| treatment | | | | | | |
| Variety III | 60 | 60 | 100 | 100 | 12.5 | — |
| control | | | | | | |
| Variety III | 20 | 60 | 100 | 100 | 1.6 | 87 |
| treatment | | | | | | |

^{$}% incidence refers to the number of infected leaves out of the total 5 that were screened.
^{λ}Disease severity decrease is calculated in relation to control.
*Control treatment consisted of leaves were dipped in 3 ml of water.

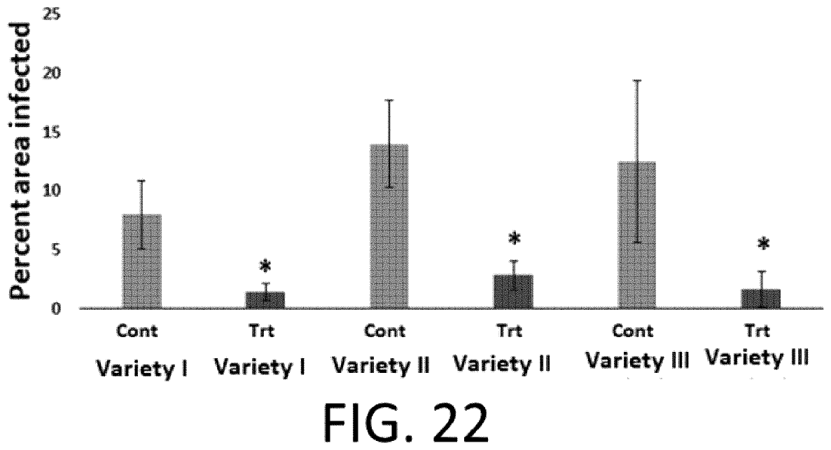

Referring now to FIG. 22, the percentage areas of infected detached Cannabis leaves from control (cont), which is water treatment, and treated (Trt) plants, which is the botanical composition 1% combined to thymol, are shown. Disease severity was calculated by the area of infected leaf divided by the total leaf area. The term “*” indicates significant difference between treatment and water control using the least significant difference (LSD) test (P<0.05).

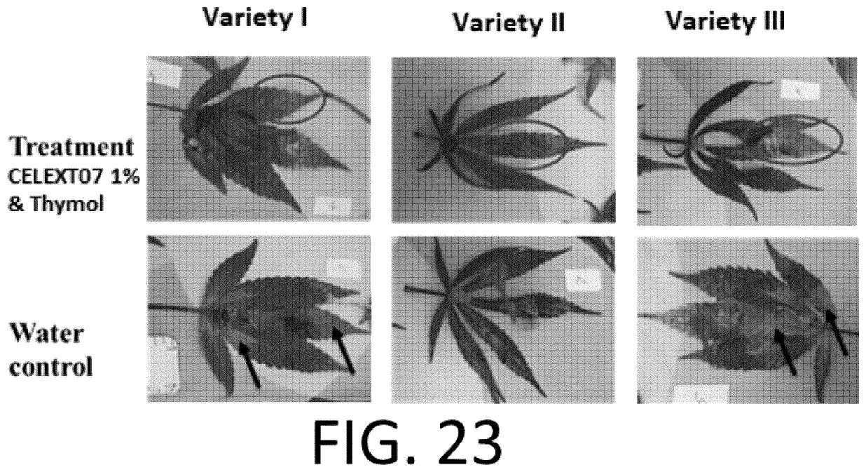

Referring now to FIG. 23, at 39 DPI, the PM infection seems to be limited to confined necrotic areas in the leaves treated with the combined dose of the botanical composition at 1% and thymol as compared to symptoms that covers the majority of the leaves in the water control. Still referring to FIG. 23, the circles shown indicate containment of the fungus in the leaves treated with a concentration of 1% botanical composition combined to thymol wherein the black arrows indicate yellowing in the water treated leaves, which signifies that the fungus is still alive. As shown, the grey arrows indicate signs of PM.

### IV. Pilot Experiment to Evaluate the Efficacy of the Botanical Extract in Disease Suppression of Powdery Mildew in Potted Cannabis

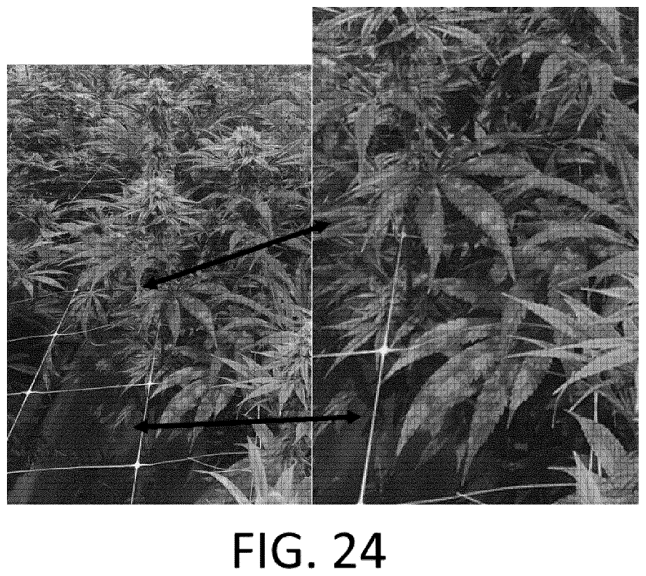

In yet another pilot experiment comprises using “Candyland” hybrid cultivar. Referring to FIG. 24, powdery mildew was present almost over most of the plants with high intensity.

The pilot experiment comprises testing several concentrations of the extract of the botanical composition, such as from 0.03 to 2%, on Cannabis plants to evaluate the preventive or curative capabilities/properties on powdery mildew. The same strain sharing the same genetics was used in the test. In such an exemplary pilot experiment for powdery mildew preventive control, the total number of plants tested was 120. The experiment comprises placing the tested plants in a room full of powdery mildew infected plants (inoculum). The exemplary experiment comprises a first group, comprising a total of 60 plants, was treated with the botanical composition and a second group, comprising 60 plants treated with the control. The experiment further comprises testing a total of 20 plants infected with powdery mildew to measure the disease elimination (curative treatment). The experiment further comprises a treatment group, the treatment group comprising 10 plants treated with the botanical composition at various concentrations, generally ranging from 0.2% to 2%. The experiment further comprises a control group. The control group comprises 10 plants treated only with water. The plants from the treatment group and the control group were always compared and plants from both groups were grown hydroponically under conventional home greenhouse conditions. The plants from the groups were treated using foliar, root drench or a combination of foliar and soil-drench.

Used in a context of disease control, the application of the botanical composition through foliar or root drench routs, or combination of both proved effective in total elimination powdery mildew from diseased plants. Concentrations ranging from 0.03 to 2% were found sufficient to eliminate the disease from treated plants. The plants that didn't receive the botanical composition showed high intensity of the disease. Also, it worth mentioning that healthy plants which received the botanical composition didn't show or develop any sign of the disease after treatment. Furthermore, two applications of the botanical composition, with a concentration ranging from 0.03 to 2%, may further be adequate to eliminate powdery mildew from the diseased plants. These results coincide with the previous tests that were performed on Cannabis and further support the biofungicidal properties of the product.

### V. Evaluation of the Antimicrobial Properties of the Combination of Botanical Composition and Thymol on Growth Suppression of Various Phytopathogens and Food Born Pathogens

In still another experiment method, various concentrations of the botanical composition, thyme leaf extract, yarrow extract, thymol and combination of the botanical composition and the previous were used to screen for their antimicrobial properties.

### Preparation of Botanical Extracts

### Single-Dose Preparation

A method for preparing a single dose of a botanical extract of the botanical composition is provided. The method for preparing a single dose comprises dissolving in water the botanical composition and serially diluting to achieve solutions of 0.5%, 1.0%, and 2.0% (w/v). The method may further comprise serially diluting up to 5.% (w/v).

The method further comprises preparing thymol at concentration of 1:256, 1:512, and 1:768.

The method also comprises preparing thyme leaf and yarrow extracts in the following proportion: 1:2 in 50% Alcohol.

### Combined-Dose Preparation

A method for preparing a combined dose of a botanical extract of the botanical composition is also provided.

The method comprises diluting each of the botanical composition and mixing the diluted botanical composition to a specific concentration of thymol.

The method further comprises using water and PDB as negative controls and using Ethanol as a positive control.

MIC Determinations: The minimum inhibitory concentrations (MIC) of the botanical products was established for cultured pathogens.

Burkholder's Assay: Referring to FIGS. 1A to 5B, to perform the bioassay with the botanical extracts of the botanical composition, thymol, thyme and yarrow leaf extract), a determined volume, such as 10 μ, of dissolved extract from each concentration was spotted on carpet of bacteria/fungi. For negative control, water drops of the same determined volume was used. Inhibition of growth in the form of clearing zone was observed after a determined duration, such as 48 hours, as in FIGS. 1A to 5B.

### Preparation of Spores or Conidia

The preparation of spores or conidia comprises growing B. cinerea and Fusarium equiseti on PDA for 3 to 4 weeks. The preparation further comprises flooding the surface of the culture plate with a volume of PDB, such as 5 ml of ¼ strength PDB passed through sterile gauze, to collect spores or conidia. In an exemplary preparation, the spore concentration/mL was adjusted to 106/ml.

### Percent Spores Inhibition and MIC Determination

The determination comprises placing in duplicate a determined volume (i.e. 5 μl) of each treatment or control onto the surface of PDA plates and incubating the placed duplicates for 48 hours to measure hyphal growth.

### Potential for Fungal Spore Germination Inhibition Using 96-Well Plate and on Growth Media

Spore collection: Target pathogens: B. cinerea and F. graminearum.

Preparation of serial dilution of botanicals mixed with spores: the powdered botanical composition was measured and diluted into solutions of 0.5%, 1.0%, and 2.0% concentration. The botanical composition may have further been diluted into solutions of up to 5.0% in other embodiments. The thyme and yarrow extract were not diluted but were filtered.

96-wells incubation: All the solutions were placed in a 96-microtiter plate and spores of F. graminearum and B. cinerea were added to the solution. Then the plate was incubated for 24 h and 48 hours. It is from that same plate that the samples for the haemocytometer and the PDA plates were taken.

Inoculation of PDA with botanical extract mixed with fungal spores: PDA plates are inoculated at 4 or 5 specific points. Each point represents a different solution of extract and fungal spores or a different concentration of the botanical composition solution mixed with fungal spores.

To test antifungal or antimicrobial efficacy of three concentrations of extracts test were done on the following organisms:

### Bacteria

| | |
|---|---|
| 1- Xanthomonas campestris | Bacterial leaf spot |
| 2- Salmonella spp. (S531) | Isolate from Food (weak) |
| 3- Salmonella spp. (S22) | Environmental (moderate) |
| 4- Salmonella spp. (SL1) | Human pathogen (strong) |

### Fungi

| | |
|---|---|
| 1- Botrytis cinerea | Grey mold |
| 2- Fusarium graminearum | Blights in wheat and barley |
| 3- Fusarium equiseti | Damping-Off and root rot |
| 4- Fusarium graminearum | Blights in wheat and barley |
| 5- Aspergillus ochraceus | Ochratoxin A |

### MIC Assays for the Determination of the Antimicrobial Efficiency of the Botanical Composition and the Other Extracts

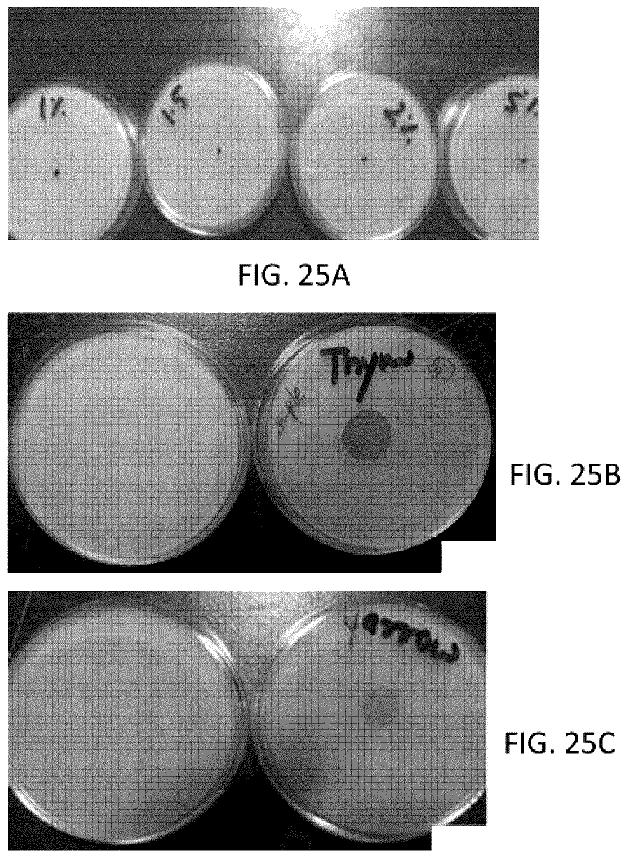

Referring now to Table 15 and FIGS. 25A to 23, although C. majus is widley known to have direct antimicrobial and antifungal properties (Móricz et al., 2015; Parvu et al., 2008;), the botanical composition diluted in water, from 0.2 to 5%, showed direct effect only on on Fusarium graminearum. Referring now to Table 15 and FIGS. 25A to 25C, thyme leaf extracts, yarrow leaf extracts and thymol were very effective against the screen bacteria and fungi as seen in Table 15 and FIGS. 25A to 25C. Referring now to FIG. 25A, Xanthomonas combined to the botanical composition extract with a concentration ranging from 1 to 5% is shown. Referring now to FIG. 25B, Xanthomonas combined to thyme extract with 1:2 in 50% alcohol is shown. Referring now to FIG. 25C, Xanthomonas combined to yarrow extract with 1:2 in 50% alcohol is shown. The bioassay was performed with the botanical extracts (the botanical composition, thymol, thyme and yarrow leaf extract). A determined volume (such as 10 μl) of dissolved extract from each concentration is spotted on carpet of bacteria.

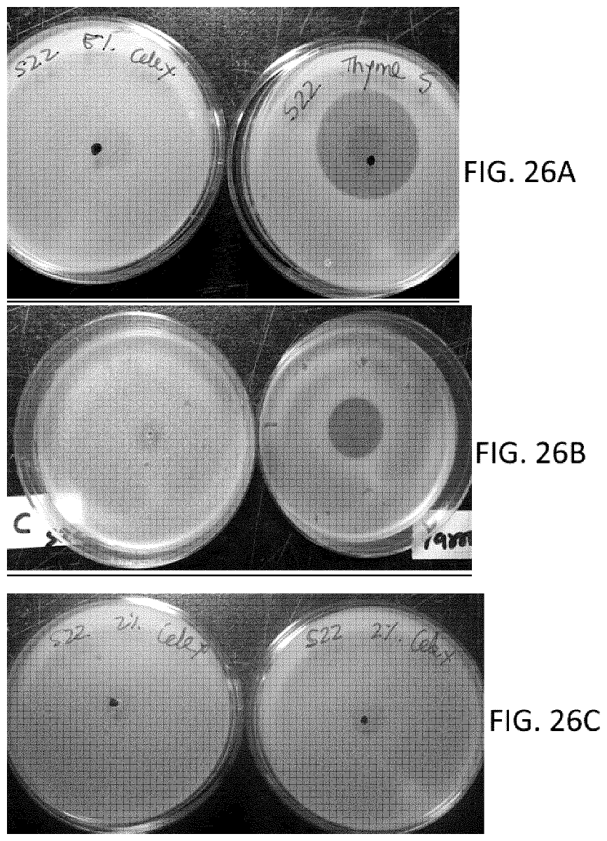

Referring now to FIGS. 26A to 26C, environmental Salmonella (S22) treated with thyme, yarrow, the botanical composition and control (C) are shown. The bioassay was performed with the botanical extracts (the botanical composition, thymol, thyme and yarrow leaf extract). A determined volume of (i.e. 10 μl) dissolved extract from each concentration is spotted on carpet of bacteria.

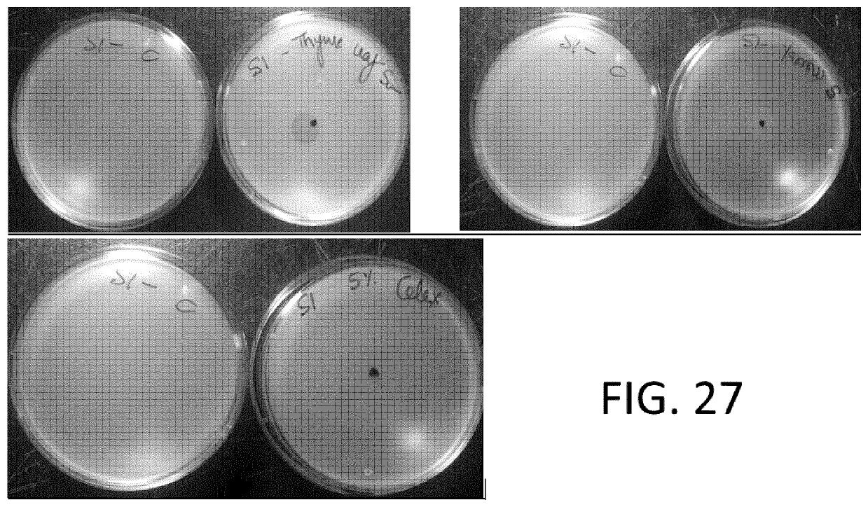

Referring now to FIG. 27, the left illustration shows pathogenic Salmonella (S1) with control and the right illustration shows Salmonella (S1) treated with thyme, yarrow extracts and the botanical composition. The bioassay was performed with the botanical extracts (the botanical composition, thymol, thyme and yarrow leaf extract), a determined volume (i.e. 10 μl) of dissolved extract from each concentration is spotted on carpet of bacteria.

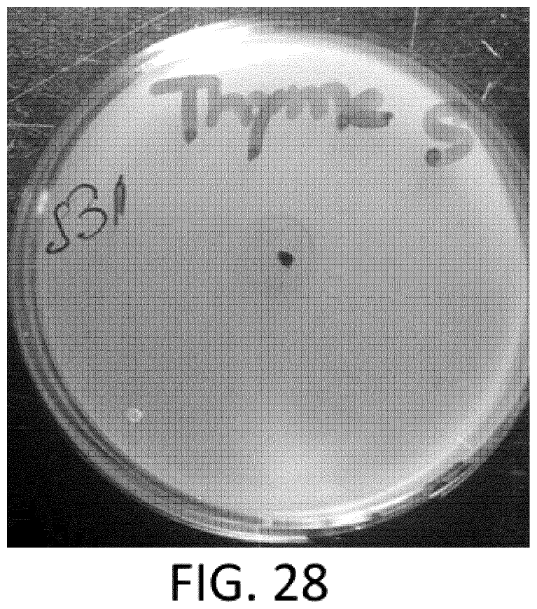

Referring now to FIG. 28, Salmonella (S31—mungbean sprout isolate) treated with thyme is shown. Such treatment seems to be the most effective. The bioassay was performed with the botanical extracts (the botanical composition, thymol, thyme and yarrow leaf extract), a determined volume (i.e. 10 μl) of dissolved extract from each concentration is spotted on carpet of bacteria.

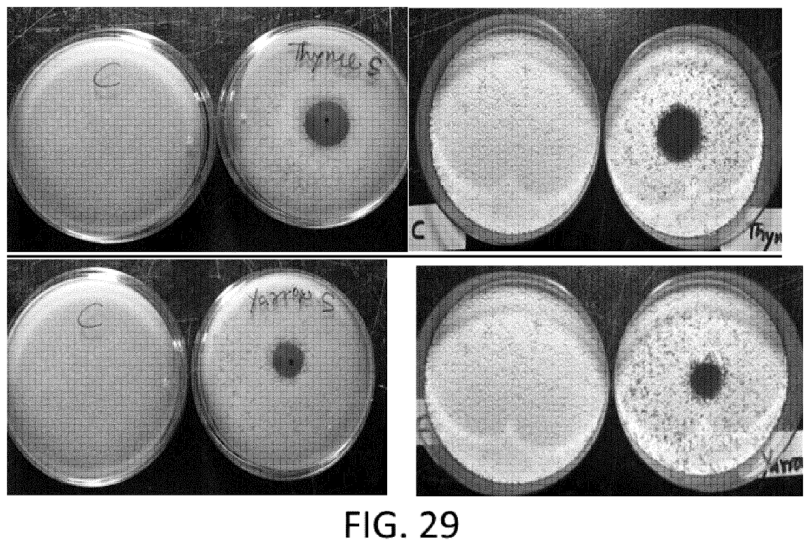

Referring now to FIG. 29, Streptomyces scabies with thyme (upper pictures) and yarrow extracts (lower pictures) are shown. The bioassay was performed with the botanical extracts (the botanical composition, thymol, thyme and yarrow leaf extract), a determined volume (i.e. 10 μl) of dissolved extract from each concentration was spotted on carpet of bacteria

TABLE 15
Bioassays of extracts with fungi and bacteria.

| | Extract | | | | | | | | |
|---|---|---|---|---|---|---|---|---|---|
| | | | | | | | | Thyme | Yarrow |
| | | | | | | | Bot. | leaf | leaf |
| | Bot. | Bot. | Bot. | Bot. | Bot. | Bot. | Comp. | 1:2 in | 1:2 in |
| | Comp. | Comp. | Comp. | Comp. | Comp. | Comp. | (50% | 50% | 50% |
| Organisms | (0.2%) | (0.5%) | (1%) | (1.5%) | (2%) | (5%) | ethanol) | ethanol | ethanol |
| Xanthomonas | — | — | — | — | — | — | — | 9 | 7 |
| compestris | | | | | | | | | |
| Pathogenic | — | — | — | — | — | — | — | 6 | — |
| Salmonella | | | | | | | | | |
| (S1) | | | | | | | | | |
| Env. | — | — | — | — | 5 | 7 | — | 23 | 14 |
| Salmonella | | | | | | | | | |
| (S22) | | | | | | | | | |
| Salmonella | — | — | — | — | — | — | — | 9 | — |
| (S31) | | | | | | | | | |
| Streptomyces | — | — | — | — | — | — | | 15 | 12 |
| scabies | | | | | | | | | |

* No inhibition. Numbers in the table represent average of clearing diameter zone of three individual plates

Fusarium graminearum inoculated with 1.0% and 2.0% the botanical composition (and somewhat 0.5%) seem to have reduced growth compared to the control. No growth of fungi is observed on fungi treated with the thyme mix solutions. Both the botanical composition and the tincture inhibit the growth of hyphae.

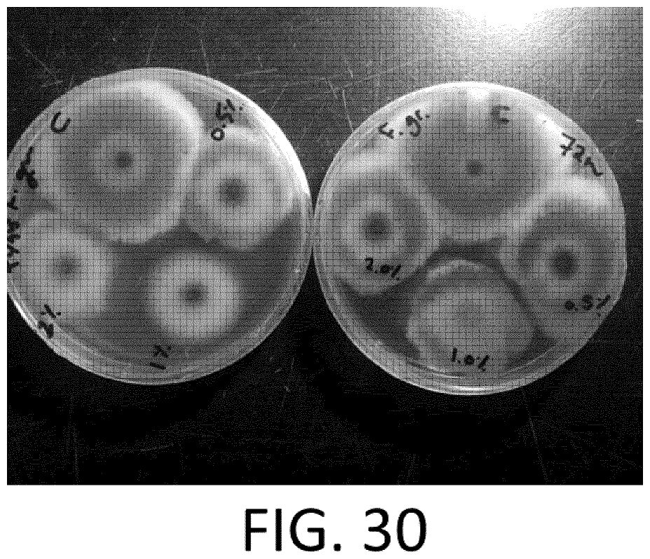

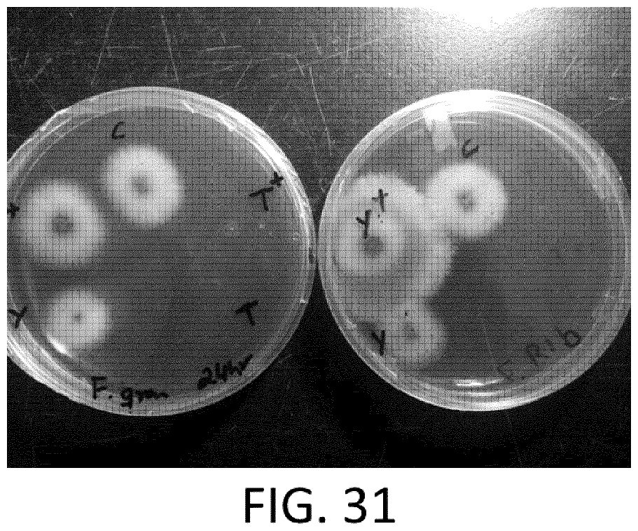

Referring to FIGS. 30 and 31 and to Table 16, the yarrow extract seems to inhibit the growth of the Fusarium pathogen with more efficiency than the control of a commercially available product. Referring now to FIG. 30, the growth of Fusarium graminearum after inoculation with the botanical composition at exemplary concentrations of 0.5%, 1.0% and 2.0% is shown. In FIG. 30, the PDA on the left plate is shown 24 hours after being inoculated with F. graminearum and the PDA on the right plate is shown 72 hours after being inoculated with F. graminearum. Referring now to FIG. 31, the growth of Fusarium graminearum is shown after inoculation with thyme and yarrow extracts. In FIG. 31, the PDA plate on the left is shown 24 hours after being inoculated with F. graminearum. The PDA plate on the right is shown 48 hours after being inoculated with F. graminearum. The term “T” means thyme leaf and the term “Y” means yarrow extracts, such terms T and Y refers to thyme leaf and yarrow extracts both developed and prepared by the Applicant. The term “T+” means thyme and the term “Y+” means yarrow extracts, both of terms referring to commercially available thyme and yarrow extracts.

TABLE 16
Average growth of Fusarium g. x the botanical composition and Fusarium x thyme and yarrow extracts.
Fusarium graminearum

| 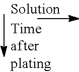 | Control (H₂O) | 0.5% | 1.0% | 2.0% | Thyme Mondias | Yarrow Mondias | Thyme commercial | Yarrow Commercial |
|---|---|---|---|---|---|---|---|---|
| 24 | 2.83 | 2.72 | 2.85 | 2.82 | — | 0.55 | — | 1.38 |
| hours | | | | | | | | |
| 48 | 3.97 | 3.28 | 3.18 | 3.42 | — | 1.28 | — | 1.98 |
| hours | | | | | | | | |

*Numbers represent the average of 6 replicates/concentration in cm/“-” represents no growth.

Referring to Table 16, the botanical composition is believed to allows thymol to be effective as an antimicrobial or antifungal agent in concentrations that are not effective when thymol is used alone on the following bacteria/fungi:

| | |
|---|---|
| 1- Xanthomonas campestris | Bacterial leaf spot |
| 2- Salmonella spp. (S531) | Isolate from Food (weak) |
| 3- Salmonella spp. (S22) | Environmental (moderate) |
| 4- Salmonella spp. (SL1) | Human pathogen (strong) |
| 5- Aspergillus ochraceus | |

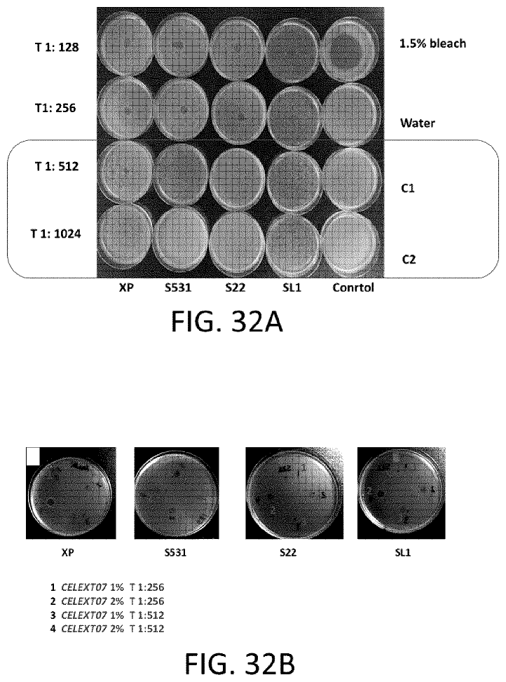

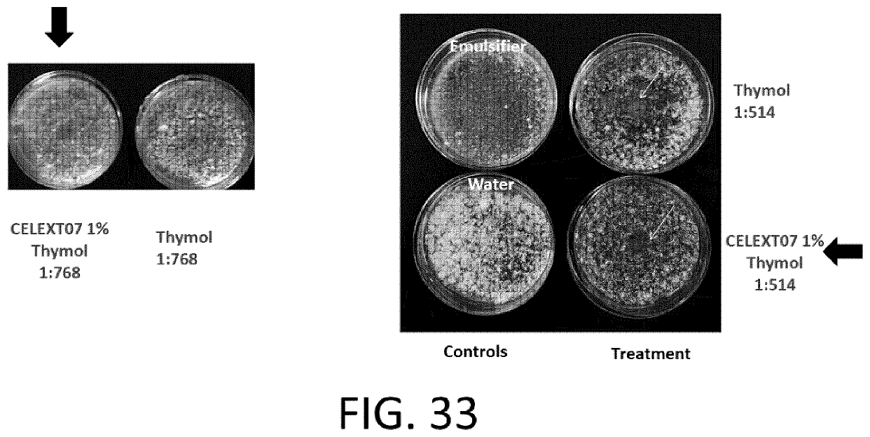

A synergistic effect is also contemplated with other commercial botanicals, such as thymol. Referring to FIGS. 32A to 33, such combination led to improved antimicrobial properties. The botanical composition at a concentration of 2% was very effective on the above bacteria (1 to 4) in combination with thymol 1:512, knowing that single dose of thymol 1:512 is not effective. The same pattern was observed on pathogenic strains of E. coli.

Referring now to FIG. 32, as for Aspergillus ochraceus, the botanical composition at a concentration of 1% in combination with thymol 1:768 was observed to enough to effectively stop the growth of Aspergillus ochraceus fungus, knowing that thymol 1:768 alone is not effective. Referring now to FIG. 32A, antimicrobial and MIC assays using the botanical composition are shown. Referring to FIG. 32B, a combination of the botanical composition and of a commercial thymol is shown. Xanthomonas campestris (XP), Salmonella spp. (S531), Salmonella spp. (S22) and Salmonella spp. (SL1) were treated with the botanical composition only or with a combination of the botanical composition and a commercially available thymol. A bioassay was performed with the above botanical extracts. Performing the bioassay comprises spotting a determined volume (i.e. 10 μl) of dissolved extract from each concentration on carpet of the above-mentioned bacteria.

Referring now to FIG. 33, Aspergillus ochraceus antifungal and MIC assays using the botanical composition or a combination of the botanical composition and a commercially available thymol are shown. Aspergillus ochraceus was treated with the botanical composition alone or with a combination of the botanical composition and a commercially available thymol. The bioassay was performed with the botanical extracts spotting a determined volume (i.e. 10 μl) of dissolved extract from each concentration on a carpet of fungi.

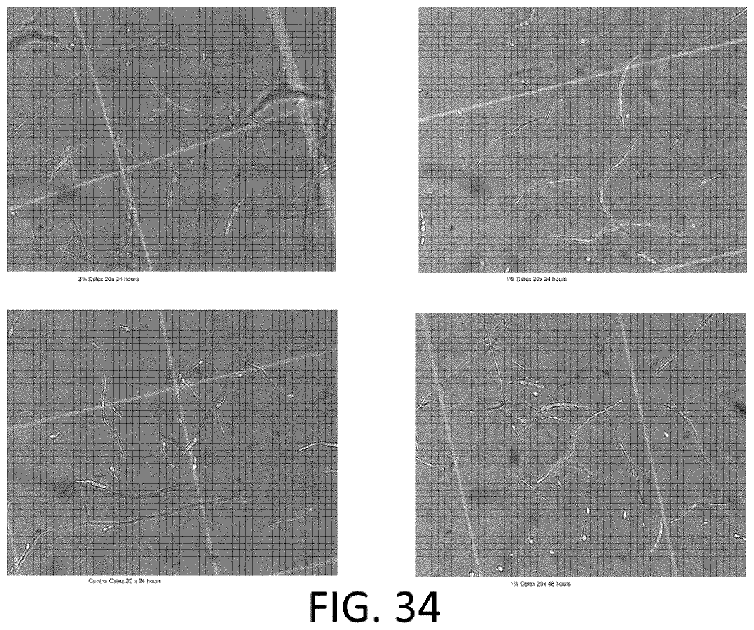

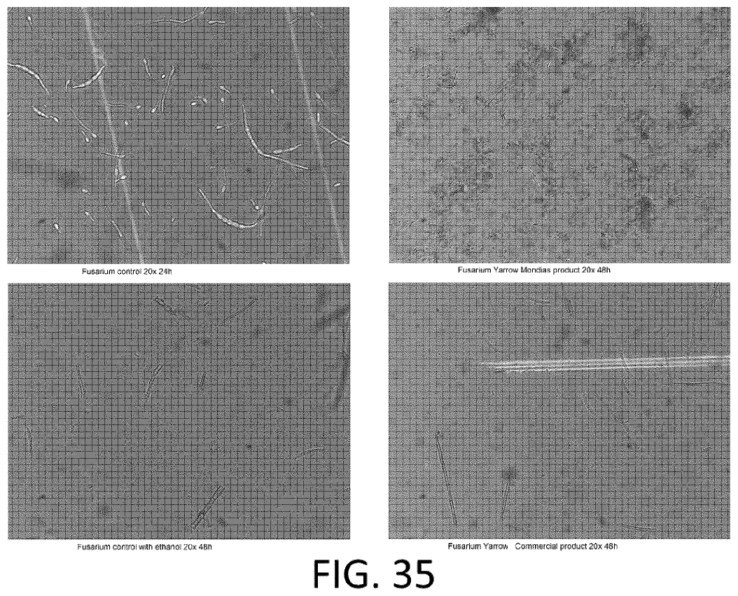

Referring now to FIGS. 34 and 35 and to Table 17, an in vitro study assessing the germination rate of Botrytis cinerea and Fusarium graminearum was executed. The in vitro study showed that the botanical composition had a stimulatory effect on spore germination. Irrespective of the target pathogen, the botanical composition appears to have a stimulatory effect of spore germination with increasing concentration after 24 hours of exposure. Interestingly after 48 h of exposure, the percentage (%) of germination was similar in all treatments including the controls. After 48 hours, F. graminearum grown in PDB had 53% of spores germinated when treated with yarrow and thyme.

Referring now to FIG. 35 and Table 17, treatments with thyme and yarrow showed complete inhibition as well as treatment with 35% ethanol. Such results indicate that the 35% percentage of ethanol is toxic. Referring now to FIG. 34, a view (20×) of Fusarium graminearum spores germinating after being incubated in a solution of the botanical composition is shown. FIG. 35 illustrates, from top left in a clockwise direction: 2% solution of the botanical composition at 24 h, 1% concentration of the botanical composition solution at 24 h, Control solution of the botanical composition at 24 h, and 1% solution of the botanical composition at 48 h. It can be observed that usarium spores are germinating irrespectively of the concentration of the botanical composition. Still referring to FIG. 35, a view (20×) of Fusarium graminearum spores germinating after being incubated in a solution of yarrow extract is shown. FIG. 35 illustrates, from top left in a clockwise direction: a positive control at 24 h, a yarrow product in accordance with the principles of the present invention at 48 hours, yarrow of a commercially available product at 48 h, and negative control at 48 h.

TABLE 17
Germination rate of Botrytis cinerea and Fusarium graminearum
after 24 and 48 hours of incubation with the botanical composition
at 0.5%, 1.0%, and 2.0% concentrations

| | | | | |
|---|---|---|---|---|
| 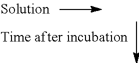 | Control (H₂O) | 0.5% botanical composi- tion | 1.0% botanical composi- tion | 2.0% botanical composi- tion |

Botrytis cinerea

| | | | | |
|---|---|---|---|---|
| 24 hours | 2% | 16% | 24% | 21% |
| 48 hours | 10% | 15% | 12% | 24% |

Fusarium graminearum

| | | | | |
|---|---|---|---|---|
| 24 hours | 33% | 48% | 67% | 65% |
| 48 hours | 52% | 63% | 57% | 53% |

*All data was taken with a haemocytometer and a microscope. All percentages represent the number of spores with germ tubes measuring x ≥ 1.5x length of the spore over 100 spores randomly selected on the haemocytometer.

In summary and referring to Table 17 and to FIGS. 32A to 35, in vitro studies showed that the botanical composition diluted in water alone does not have direct antifungal or antibacterial activity. Only antifungal properties were observed on F. graminarium. In vitro studies further demonstrated that thyme and the yarrow extracts are the only botanical extracts that have antifungal and antibacterial inhibitory properties. Meanwhile, the botanical composition is shown to improve the antifungal and antimicrobial properties of thyme leaf extract or thymol when used in combination. The botanical composition is believed to allow thymol to be effective as an antimicrobial or antifungal agent in concentrations that are not effective when thymol is used alone. Finally, an in vitro study assessing the germination rate of Botrytis cinerea and Fusarium graminearum showed that the botanical composition had a stimulatory effect on spore germination.

At concentration rates below 2% of the botanical composition, the herbal extract does not cause any phytotoxic response on leaves of lettuce, tomato, tobacco, hops and Cannabis when applied as foliar or soil drench treatments. The botanical composition is believed to be a safe option for the application in agricultural practices. The application of the botanical composition induced a significant increase in chlorophyll content (tomato and lettuce seedlings and tobacco mature plants), height (tomato seedlings, lettuce and tobacco) and fresh & dry weight (lettuce and tobacco) compared to controls.

The pilot experiment on Cannabis plants showed that soil-drench, foliar, or a combination (soil-drench and foliar) of concentrations ranging from 0.03 to 2% of the botanical composition lead to enhanced bud size and yield. Furthermore, the treatment of soybean seeds with a concentration of 1% of the botanical composition and/or with a combination of the botanical composition and the seaweed algae Stimulagro lead to significant enhancement on soybean growth and early growth as compared to water control. Although Stimulagro was used in these tests, other types of seaweeds or seaweed compositions may be used in combination with the botanical composition. One such example of seaweed to be used may be Ascophyllum nodosum. The botanical composition was found to have synergy with the sea algae or seaweed, irrespetive of the extraction or processing method of such sea algae or seaweed. The results mean that the botanical composition may be used as a biostimulant agent to promote the growth of plants. More so, the amendment of the botanical composition with a soil mix, such as the commercially available Agro mix® G6 (Fafard), resulted in a positive boosting impact on plants, such as but not limited to lettuce and tobacco, and promoted the growth parameters, such as but not limited to chlorophyll content, height, fresh and dry weight of such plants. The amended botanical composition further suppresses grey mold disease. Hence, soil amendment of the botanical composition with soil mixes, such as but not limited to Agro mix® (lettuce and tobacco) may help in the production of healthier plants as shown with lettuce and tobacco and is speculated to show similar results on other plants. The botanical composition components and molecules may be interacting positively with the components of a soil mix, such as Agro mix® G6 (Fafard).

The botanical extract of the botanical composition is free of direct inhibitory effect on bacteria and fungi. Only antifungal properties were observed on F. graminarium. In-vitro trails showed a potential synergistic effect with other botanicals, such as but not limited to thyme leaf and yarrow extracts and thymol, lead to improved antimicrobial properties against important bacterial or fungal Phytopathogens. The in-vitro study assessing the germination rate of Botrytis cinerea and Fusarium graminearum showed that the botanical composition had a stimulatory effect on spore germination.

Based on the repeated demonstration of a preventive and treatment antifungal effect, the botanical composition generally induces a plant-based response against the infections including potentially a type of resistance. Also, the capacity of the botanical composition to cure (e.g. powdery mildew on Cannabis) and prevent fungal diseases e.g. powdery mildew on Cannabis and grey mold on tomatoes, lettuce, and hops through foliar application or soil drench and powdery mildew on Cannabis through foliar application are generally improved over control. The botanical composition may be used as a biopesticide agent to promote the resistance of plants to fight diseases.

### VI. Metabolite Composition and Bioactivity Analysis of the Botanical Plant Extract

In yet another experiment, a composition comprising botanical plant extracts in accordance with the embodiments presented above has been analysed in order to determine the metabolites present components.

In such an experiment, two series of tests were conducted, a first on leaf extracts and a second on root extracts. In such an exemplary experiment, the analysis methods comprised QE Orbitrap MS (LC/MS/MS) and GC/EI/MS metabolite profiling.

### Leaf Extract

In the tests involving leaf extracts, the identified bioactive metabolites were found to be selected amongst the followings: apigenin, genistein, genipin, p-coumaroyltyramine 18-hydroxyoleate, 4-coumaroylquinate, chlorogenic acid, genistin, caffeoylshikimate, 15-HETE, p-Hydroxybenzoic acid, Succinic acid, Tyrosol, γ-Hydroxybutyric acid, Vanillic acid, 3-Hydroxybenzoic acid, Acetic acid, Caffeic acid, Phenylacetic acid, Phosphoric acid.

Still referring to the leaf extracts tests, the following metabolites were found to have different roles in the physiology of the plants: traumatic acid, Abscisic acid, Epijasmonic acid, jasmonate, salicyl-HCH, traumatin, gibberellin, 7-isomethyl-jasmonate, a-linolenate, indole-3-acetate, a,a-Trehalose, a-Linolenic acid, D-Fructose.

### Root Extract

In the tests involving leaf extracts, the identified bioactive metabolites were found to be selected amongst the followings: 13-epoxyoctadeca-9; 11-dienoate, ferulate, 9(S); 12(S); 13(S)-trihydroxy-10(E)-octadecenoic acid, apigenin, genistein, genipin, p-coumaroyltyramine 18-hydroxyoleate, 4-coumaroylquinate, chlorogenic acid, genistin, caffeoylshikimate, vanillin, Succinic acid, Tyrosol, γ-Hydroxybutyric acid, Vanillic Acid, 4-Coumaric acid, Acetic acid, Caffeic acid, Phenylacetic acid, Phosphoric acid, Pantothenic acid.

Still referring to the leaf extracts tests, the following metabolites were found to have different roles in the physiology of the plants: traumatic acid, Abscisic acid, Epijasmonic acid, 7-iso-jasmonate, jasmonate, salicyl-HCH, traumatin, gibberellins, 7-isomethyl-jasmonate, a-linolenate, indole-3-acetate, a,a-Trehalose, glutathione, salicylate, a-tocopherol, a-Linolenic acid, D-Fructose, GABA.

### Metabolomic Analysis

A metabolomics analysis was further conducted. The results are presented in the Table 18, showing the relative exemplary concentration of alkaloids in the compound. Alkaloids may have numerous advantages in the protection and growth of plants.

TABLE 18
Relative concentration of alkaloids in a compound comprising
botanical extracts according to a metabolomics analysis

| | Root extract | Leaf extract | |
|---|---|---|---|
| | relative | relative | Relative |
| | composition of | composition of | composition |
| | composition | composition | of C. majus |
| Alkaloid | (%) | (%) | (%) |
| All Type | 41 | 47 | 0.4 to 1.4* |
| Protopine | 29 | 33 | |
| Stylopine | 8 | 9 | |
| Dihydrosanguinarine | 1 | 1 | |
| Others | 3 | 4 | |

*Alkaloid content in C. majus could be different based on variety, plant parts, and plant growth stages and extraction methods

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A botanical composition comprising:
a granular extract of thyme leaf;
an extract of Chelidonium majus roots; and
an extract of Chelidonium majus leaves;
the composition being diluted at a concentration between 0.2% to 5% and the composition being used to promote plant growth and to prevent or supress plant diseases.

2) The botanical composition of claim 1, the composition comprising:
0.1% to 99% of the extract of Chelidonium majus roots;
0.1% to 99% of the extract of Chelidonium majus leaves; and
0.1% to 30% of the granular extract of thyme leaf.

3) The botanical composition of claim 1, the composition being diluted at a concentration between 0.5% and 5%.

4) The botanical composition of claim 1, the botanical composition having anti-bacterial and/or anti-fungal properties.

5) The botanical composition of claim 1, the botanical composition further comprising a tincture.

6) The botanical composition of claim 1, the composition further comprising seaweed.

7) The botanical composition of claim 6, the seaweed being Ascophyllum nodosum.

8) The botanical composition of claim 6, the composition comprising between 0.5 to 2 g/L of seaweed.

9) The botanical composition of claim 1, the composition further comprising an additional extract of thyme leaf.

10) The botanical composition of claim 8, the extract of thyme leaf being a thyme leaf extract diluted in 1:2 in 50% alcohol.

11) The botanical composition of claim 1, the composition further comprising thymol.

12) The botanical composition of claim 1, the composition further comprising an extract of yarrow leaf.

13) The botanical composition of claim 12, the extract of yarrow leaf being a yarrow leaf extract diluted in 1:2 in 50% alcohol.

14) The botanical composition of claim 1, the composition further comprising a soil mix.

15) The botanical composition of claim 14, the soil mix comprising coconut husk fiber.

16) The botanical composition of claim 14, the soil mix comprising peat moss and perlite.

17) The botanical composition of claim 14, the soil mix comprising mycorrhiza.

18)-33) (canceled)
